(19) United States
(12) Patent Application Publication
(10) Pub. No.: US 2025/0191198 A1
(43) Pub. Date: Jun. 12, 2025

(54) ELECTRONIC DEVICE AND METHOD FOR OBTAINING IMAGE ON BASIS OF SYNTHESIS OF FRAMES

(71) Applicant: Samsung Electronics Co., Ltd., Suwon-si (KR)

(72) Inventors: Changwoo LEE, Suwon-si (KR); Jaehun CHO, Suwon-si (KR); Dohan KIM, Suwon-si (KR)

(21) Appl. No.: 19/059,882

(22) Filed: Feb. 21, 2025

Related U.S. Application Data
(63) Continuation of application No. PCT/KR2023/009666, filed on Jul. 7, 2023.

(30) Foreign Application Priority Data
Sep. 8, 2022 (KR) 10-2022-0114557
Oct. 4, 2022 (KR) 10-2022-0126198

(51) Int. Cl. G06T 7/20; G06T 5/20; G06T 5/50; G06V 10/56; G06V 10/60

(52) U.S. Cl. CPC G06T 7/20; G06T 5/20; G06T 5/50; G06V 10/56; G06V 10/60; G06T 2207/20221; G06V 2201/07

(57) ABSTRACT

An electronic device is provided. The electronic device includes memory storing one or more computer programs, and one or more processors communicatively coupled to the memory. The one or more computer programs include computer-executable instructions that, when executed by the one or more processors individually or collectively, cause the electronic device to identify, based on an input to synthesize frames obtained based on a first period, information indicating a motion included in at least one of frames, obtain, based on identifying at least one light source from at least one of the frames based on the information, an image representing a motion of the at least one light source between the frames, by synthesizing the frames based on the motion of the at least one light source, and obtain, based on identifying a motion of an external object different from the at least one light source based on the information, an image with respect to the frames by synthesizing one or more frames sampled from the frames based on a second period longer than the first period.

### CROSS-REFERENCE TO RELATED APPLICATION(S)

This application is a continuation application, claiming priority under § 365(c), of an International application No. PCT/KR2023/009666, filed on Jul. 7, 2023, which is based on and claims the benefit of a Korean patent application number 10-2022-0114557, filed on Sep. 8, 2022, in the Korean Intellectual Property Office, and of a Korean patent application number 10-2022-0126198, filed on Oct. 4, 2022, in the Korean Intellectual Property Office, the disclosure of each of which is incorporated by reference herein in its entirety.

### BACKGROUND

### 1. Field

The disclosure relates to an electronic device and a method for obtaining an image on the basis of a synthesis of frames.

### 2. Description of Related Art

A compact system camera (CSC) may support various functions associated with image capture by adjusting an image sensor and/or external light transmitted to film based on control of an aperture. The functions may include a function (e.g., a slow shutter function) that opens the aperture for a relatively long period of time to represent a trajectory and/or flow of an object captured by the CSC in the period. In a state controlled based on the slow shutter function, the CSC may obtain information on the image sensor at a single moment after the aperture is opened for a designated period of time.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device and a method for obtaining an image on the basis of a synthesis of frames.

Additional aspects will be set forth in part in the description which follows and, in part, will be apparent from the description, or may be learned by practice of the presented embodiments.

In accordance with an aspect of the disclosure, an electronic device is provided. The electronic device includes memory storing one or more computer programs, and one or more processors communicatively coupled to the memory. The one or more computer programs include computer-executable instructions that, when executed by the one or more processors individually or collectively, cause the electronic device to identify, based on an input to synthesize frames obtained based on a first period, information indicating a motion included in at least one of the frames, obtain, based on identifying at least one light source from at least one of the frames based on the information, an image representing a motion of the at least one light source between the frames, by synthesizing the frames based on the motion of the at least one light source, and obtain, based on identifying a motion of an external object distinct from the at least one light source based on the information, an image with respect to the frames by synthesizing one or more frames sampled from the frames based on a second period longer than the first period.

In accordance with another aspect of the disclosure, a method performed by an electronic device is provided. The method includes identifying, based on an input to synthesize frames obtained based on a first period, information indicating a motion included in at least one of the frames; obtaining, based on identifying at least one light source from at least one of the frames based on the information, an image representing a motion of the at least one light source between the frames, by synthesizing the frames based on the motion of the at least one light source; and obtaining, based on identifying a motion of an external object different from the light source based on the information, an image with respect to the frames by synthesizing one or more frames sampled from the frames based on a second period longer than the first period.

In accordance with another aspect of the disclosure, an electronic device is provided. The electronic device includes memory storing one or more computer programs, and one or more processors communicatively coupled to the memory. The one or more computer programs include computer-executable instructions that, when executed by the one or more processors individually or collectively, cause the electronic device to identify, based on an input to synthesize frames obtained based on a camera, brightness of at least one of the frames, obtain, based on identifying a visual object corresponding to a light source from the frames using the brightness, information associated with a path of the visual object captured by the frames, and obtain, by synthesizing the frames based on the information, an image in which the path of the visual object is represented.

In accordance with another aspect of the disclosure, a method performed by an electronic device is provided. The method includes identifying, based on an input to synthesize frames obtained based on a camera, brightness of at least one of the frames; obtaining, based on identifying a visual object corresponding to a light source from the frames using the brightness, information associated with a path of the visual object captured by the frames; and obtaining, by synthesizing the frames based on the information, an image in which the path of the visual object is represented.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device according to an embodiment of the disclosure;

FIG. 2 is a block diagram exemplifying a camera module according to an embodiment of the disclosure;

FIGS. 3A and 3B illustrate an example of an operation in which an electronic device receives an input to synthesize frames, according to various embodiments of the disclosure;

FIG. 4 is a block diagram of an electronic device according to an embodiment of the disclosure;

FIG. 5 illustrates an example of an operation in which an electronic device selects a synthesis mode to synthesize frames, according to an embodiment of the disclosure;

FIG. 6 illustrates an example of an operation in which an electronic device identifies brightness of each of frames, according to an embodiment of the disclosure;

FIG. 7 illustrates an example of an operation in which an electronic device synthesizes frames based on interpolation of frames, according to an embodiment of the disclosure;

FIG. 8 illustrates an example of an operation in which an electronic device synthesizes frames based on sampling of the frames, according to an embodiment of the disclosure;

FIG. 9 illustrates an example of an operation in which an electronic device synthesizes frames based on a motion of a light source captured by the frames, according to an embodiment of the disclosure;

FIGS. 10A and 10B illustrate signal flowcharts to synthesize frames by an electronic device according to various embodiments of the disclosure;

FIG. 11 illustrates an example of a flowchart to describe an operation performed by an electronic device according to an embodiment of the disclosure;

FIG. 12 illustrates an example of a flowchart to describe an operation performed by an electronic device according to an embodiment of the disclosure; and

FIG. 13 illustrates an example of a flowchart to describe an operation performed by an electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In relation to the description of the drawings, a reference numeral may be used for a similar component. In the document, an expression such as “A or B”, “at least one of A and/or B”, “A, B or C”, or “at least one of A, B and/or C”, and the like may include all possible combinations of items listed together. Expressions such as “1st”, “2nd”, “first” or “second”, and the like may modify the corresponding components regardless of order or importance, is only used to distinguish one component from another component, but does not limit the corresponding components. When a (e.g., first) component is referred to as “connected (functionally or communicatively)” or “accessed” to another (e.g., second) component, the component may be directly connected to the other component or may be connected through another component (e.g., a third component).

The term “module” used in the document may include a unit configured with hardware, software, or firmware, and may be used interchangeably with terms such as logic, logic block, component, or circuit, and the like. The module may be an integrally configured component or a minimum unit or part thereof that performs one or more functions. For example, a module may be configured with an application-specific integrated circuit (ASIC).

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

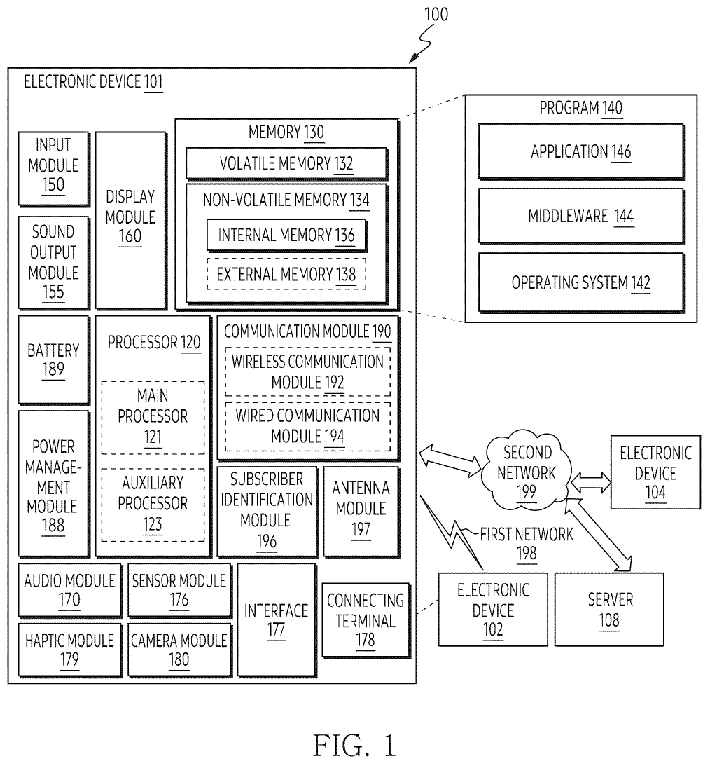

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

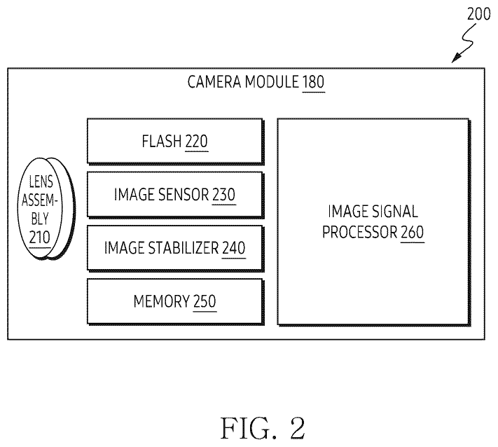

FIG. 2 is a block diagram 200 illustrating the camera module 180 according to an embodiment of the disclosure.

Referring to FIG. 2, the camera module 180 may include a lens assembly 210, a flash 220, an image sensor 230, an image stabilizer 240, memory 250 (e.g., buffer memory), or an image signal processor 260. The lens assembly 210 may collect light emitted or reflected from an object whose image is to be taken. The lens assembly 210 may include one or more lenses. According to an embodiment, the camera module 180 may include a plurality of lens assemblies 210. In such a case, the camera module 180 may form, for example, a dual camera, a 360-degree camera, or a spherical camera. Some of the plurality of lens assemblies 210 may have the same lens attribute (e.g., view angle, focal length, auto-focusing, f number, or optical zoom), or at least one lens assembly may have one or more lens attributes different from those of another lens assembly. The lens assembly 210 may include, for example, a wide-angle lens or a telephoto lens.

The flash 220 may emit light that is used to reinforce light reflected from an object. According to an embodiment, the flash 220 may include one or more light emitting diodes (LEDs) (e.g., a red-green-blue (RGB) LED, a white LED, an infrared (IR) LED, or an ultraviolet (UV) LED) or a xenon lamp. The image sensor 230 may obtain an image corresponding to an object by converting light emitted or reflected from the object and transmitted via the lens assembly 210 into an electrical signal. According to an embodiment, the image sensor 230 may include one selected from image sensors having different attributes, such as a RGB sensor, a black-and-white (BW) sensor, an IR sensor, or a UV sensor, a plurality of image sensors having the same attribute, or a plurality of image sensors having different attributes. Each image sensor included in the image sensor 230 may be implemented using, for example, a charged coupled device (CCD) sensor or a complementary metal oxide semiconductor (CMOS) sensor.

The image stabilizer 240 may move the image sensor 230 or at least one lens included in the lens assembly 210 in a particular direction, or control an operational attribute (e.g., adjust the read-out timing) of the image sensor 230 in response to the movement of the camera module 180 or the electronic device 101 including the camera module 180. This allows compensating for at least part of a negative effect (e.g., image blurring) by the movement on an image being captured. According to an embodiment, the image stabilizer 240 may sense such a movement by the camera module 180 or the electronic device 101 using a gyro sensor (not shown) or an acceleration sensor (not shown) disposed inside or outside the camera module 180. According to an embodiment, the image stabilizer 240 may be implemented, for example, as an optical image stabilizer. The memory 250 may store, at least temporarily, at least part of an image obtained via the image sensor 230 for a subsequent image processing task. For example, if image capturing is delayed due to shutter lag or multiple images are quickly captured, a raw image obtained (e.g., a Bayer-patterned image, a high-resolution image) may be stored in the memory 250, and its corresponding copy image (e.g., a low-resolution image) may be previewed via the display module 160. Thereafter, if a specified condition is met (e.g., by a user's input or system command), at least part of the raw image stored in the memory 250 may be obtained and processed, for example, by the image signal processor 260. According to an embodiment, the memory 250 may be configured as at least part of the memory 130 or as a separate memory that is operated independently from the memory 130.

The image signal processor 260 may perform one or more image processing with respect to an image obtained via the image sensor 230 or an image stored in the memory 250. The one or more image processing may include, for example, depth map generation, three-dimensional (3D) modeling, panorama generation, feature point extraction, image synthesizing, or image compensation (e.g., noise reduction, resolution adjustment, brightness adjustment, blurring, sharpening, or softening). Additionally or alternatively, the image signal processor 260 may perform control (e.g., exposure time control or read-out timing control) with respect to at least one (e.g., the image sensor 230) of the components included in the camera module 180. An image processed by the image signal processor 260 may be stored back in the memory 250 for further processing, or may be provided to an external component (e.g., the memory 130, the display module 160, the electronic device 102, the electronic device 104, or the server 108) outside the camera module 180. According to an embodiment, the image signal processor 260 may be configured as at least part of the processor 120, or as a separate processor that is operated independently from the processor 120. If the image signal processor 260 is configured as a separate processor from the processor 120, at least one image processed by the image signal processor 260 may be displayed, by the processor 120, via the display module 160 as it is or after being further processed.

According to an embodiment, the electronic device 101 may include a plurality of camera modules 180 having different attributes or functions. In such a case, at least one of the plurality of camera modules 180 may form, for example, a wide-angle camera and at least another of the plurality of camera modules 180 may form a telephoto camera. Similarly, at least one of the plurality of camera modules 180 may form, for example, a front camera and at least another of the plurality of camera modules 180 may form a rear camera.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

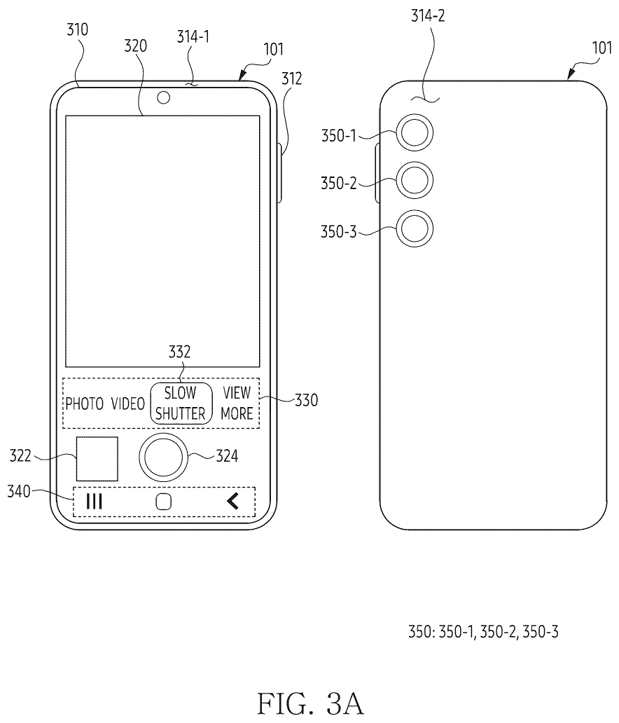

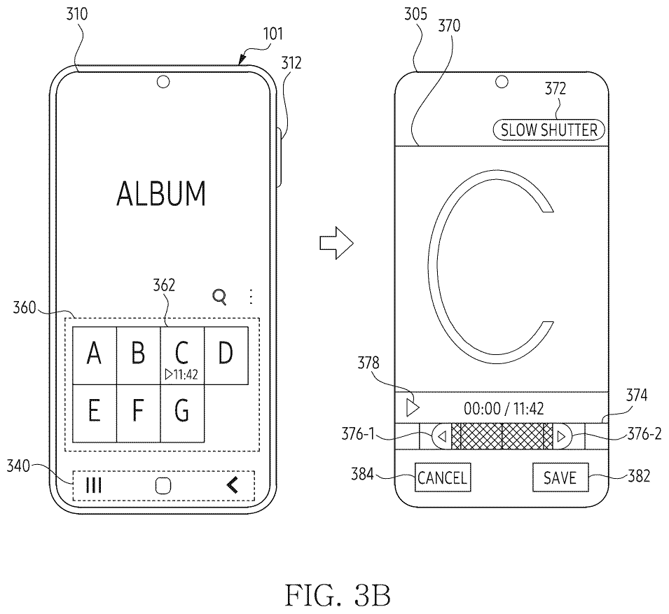

FIGS. 3A and 3B illustrate an example of an operation in which an electronic device 101 receives an input to synthesize frames, according to various embodiments of the disclosure. FIGS. 3A and 3B may be an example of the electronic device 101 of FIGS. 1 and 2. The electronic device 101 of FIGS. 3A and 3B may be a terminal owned by a user. The terminal may include, for example, a personal computer (PC) such as a laptop and a desktop, a smartphone, a smartpad, and/or a tablet PC. An embodiment is not limited thereto, and the terminal may include a smart accessory such as a smartwatch and/or a head-mounted device (HMD).

According to an embodiment, the electronic device 101 may synthesize a plurality of frames having a stationary field-of-view (FoV), based on a slow shutter function. The slow shutter function may mean a function of obtaining a single image representing a motion of an external object continuously moved in a time section in which an aperture is opened. According to an embodiment, the electronic device 101 may execute the slow shutter function based on a plurality of frames discretely obtained along a period less than the time section. For example, the electronic device 101 may obtain a single image as a result of synthesizing the plurality of frames, based on the slow shutter function. The image synthesized from the plurality of frames may include a trajectory of at least one external object continuously moved in the time section in which the plurality of frames is obtained.

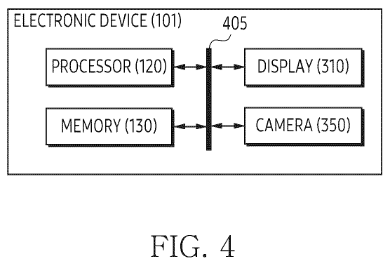

According to an embodiment, the electronic device 101 may synthesize the plurality of frames in real time or execute the slow shutter function, based on postprocessing for the plurality of frames. Referring to FIG. 3A, an example of a state in which the electronic device 101 according to an embodiment synthesizes the plurality of frames obtained from a camera 350 in real time is illustrated. Referring to FIG. 3B, an example of a state in which the electronic device 101 according to an embodiment synthesizes the plurality of frames pre-stored in the electronic device 101 is illustrated. A structure of hardware included in the electronic device 101 will be described with reference to FIG. 4.

Referring to FIG. 3A, the electronic device 101 according to an embodiment may include the camera 350 configured to output data from an image sensor along a designated period. The data may be obtained based on a method in which a controller (e.g., the ISP 260 of FIG. 2) in the camera 350 sequentially accesses image sensors in the camera 350, such as a rolling shutter. The method of obtaining the data is not limited to the above-described rolling shutter, and may include a global shutter. The designated period associated with the camera 350 may be referred to as a frame rate. The designated period may be adjusted by the camera 350 to initialize the image sensors in the camera 350. Initialization of the image sensors may be performed by the camera 350 to reduce interference between frames. The camera 350 may output one or more frames captured by the image sensor along the designated period, based on the data obtained along the designated period from the image sensor. The electronic device 101 may obtain the plurality of frames to be used for the slow shutter function based on the plurality of frames outputted from the camera 350.

Referring to FIG. 3A, the electronic device 101 may control the camera 350, based on execution of a designated application such as a camera application. In an embodiment in which the electronic device 101 includes a display 310 disposed on a first surface 314-1 of a housing and a second surface 314-2 opposite to the first surface 314-1, a plurality of cameras (e.g., a first camera 350-1, a second camera 350-2, and a third camera 350-3) may be exposed to an outside through the second surface 314-2. The electronic device 101 may activate any one of the first camera 350-1, the second camera 350-2, and the third camera 350-3 based on the execution of the designated application. Based on at least a portion of frames obtained from an activated camera, the electronic device 101 may display a preview image 320 in the display 310.

Referring to FIG. 3A, an example of a screen which the electronic device 101 according to an embodiment displayed in the display 310, based on a designated application to control the camera 350 is illustrated. Hereinafter, the screen may mean a user interface (UI) displayed in at least a portion of the display. The screen may include, for example, an activity of an Android operating system. Together with the preview image 320 displayed in the display 310, the electronic device 101 may display a visual object 324 for receiving a designated input (e.g., a shooting input) associated with the camera 350. The visual object 324 may include an icon of a designated form to represent the shutter. Based on a gesture of touching (e.g., tap) and/or clicking the visual object 324, the electronic device 101 may receive the shooting input. The shooting input is not limited to the gesture associated with the visual object 324, and may include a gesture of pressing a button 312 exposed to the outside through a portion of the housing of the electronic device 101. The button 312 may be mapped to a function (e.g., a function of adjusting a volume of an audio signal outputted by the electronic device 101) distinct from the shooting input in another time section distinct from the time section in which the designated application to control the camera 350 is executed.

Referring to FIG. 3A, the electronic device 101 may display a visual object 322 for browsing one or more images and/or videos stored in the electronic device 101 together with the preview image 320 in the display 310. The visual object 322 may include a thumbnail of the most recently stored image and/or video among the one or more images and/or videos stored in the electronic device 101. The electronic device 101 may display, in a designated area 340 of the display 310, a screen displayed in the display 310, and/or distinct options to change the application executed by the electronic device 101. The designated area 340 may be referred to as a navigation bar.

Referring to FIG. 3A, the electronic device 101 according to an embodiment may display a list 330 of distinct functions to control the camera 350 in the display 310. The list 330 may be associated with a type of multimedia content to be stored in the electronic device 101 by the shooting input. For example, an option with text such as “photo” in the list 330 may indicate a function to obtain a single image, based on the shooting input. For example, an option with text such as “video” in the list 330 may indicate a function to obtain a video based on the shooting input. For example, an option 332 with text such as “slow shutter” in the list 330 may indicate a function to obtain an image in which the plurality of frames is synthesized by executing the slow shutter function based on the shooting input. The embodiment is not limited thereto, and based on an option such as “view more” in the list 330, the electronic device 101 may further display other options distinct from the exemplified options.

Referring to FIG. 3A, a state in which the electronic device 101 according to an embodiment receives an input indicating selecting the slow shutter function is illustrated. In the state of FIG. 3A, the electronic device 101 may emphasize the option 332 in the list 330. Emphasizing the option 332 may include adjusting color, a size, and/or a boundary line of the text included in the option 332 to indicate that the option 332 is selected. Referring to FIG. 3A, an example is illustrated in which a figure of a designated shape corresponding to the option 332 is displayed, but the embodiment is not limited thereto.

According to an embodiment, the electronic device 101 may synthesize the frames received from the camera 350 based on the execution of the slow shutter function in response to the reception of the shooting input based on the visual object 324 in the state of FIG. 3A. The time section in which the electronic device 101 obtains the frames to be used for image synthesis from the camera 350 may correspond to a time section immediately after receiving the shooting input or correspond to another time section before receiving the shooting input. For example, during a time section having the designated period from a time point when the visual object 324 is selected, the electronic device 101 may obtain the frames to be synthesized based on the slow shutter function. For example, in response to the input indicating selecting the visual object 324, the electronic device 101 may select the frames stored in a buffer formed in memory as the frames to be synthesized based on the slow shutter function. The buffer may be formed in the memory to store the frames received from the camera 350 in a time section of the designated period having a current time point as a terminal moment based on a data structure such as a queue. In an embodiment, the electronic device 101 that has obtained the image in which the frames are synthesized may store the obtained image in the memory of the electronic device 101. In response to storing the image in the memory, the electronic device 101 may change the thumbnail included in the visual object 322 into another thumbnail to represent the obtained image.

Referring to FIG. 3B, the electronic device 101 may display a list of multimedia content stored in the electronic device 101 in the display 310, based on the execution of the designated application such as a gallery application. Referring to the state of FIG. 3B, the electronic device 101 may display one or more thumbnails representing the multimedia content (e.g., the image, and/or the video) stored in the electronic device 101 in a portion 360 of a display area of the display 310. Similar to the state of FIG. 3A, the electronic device 101 may display, in the designated area 340 of the display 310, a screen displayed in the display 310, and/or distinct options to change the application executed by the electronic device 101.

Referring to FIG. 3B, the electronic device 101 may identify an input indicating that one video is selected in the list displayed through the portion 360. Based on an input indicating that one thumbnail 362 is selected, displayed in the portion 360, the electronic device 101 may display a screen 305 to play the video corresponding to the thumbnail 362. Based on an area 370 of the screen 305, the electronic device 101 may play the video corresponding to the thumbnail 362. According to an embodiment, the electronic device 101 may display a visual object 378 (e.g., a play button) to control playback of the video displayed through the area 370 in the screen 305. The electronic device 101 may execute the slow shutter function to synthesize at least a portion of the video displayed by the screen 305, based on a visual object 372 displayed in the screen 305. For example, in response to an input indicating that the visual object 372 is selected, the electronic device 101 may display a visual object 374 to select at least a portion of the video. The visual object 374 may include a timeline of the video displayed by the screen 305.

Referring to FIG. 3B, based on handles 376-1 and 376-2 overlapping on the visual object 374, the electronic device 101 may identify the time section corresponding to the frames in the video to be synthesized based on the execution of the slow shutter function. For example, based on a single time section distinguished in the visual object 374 by the handles 376-1 and 376-2, the electronic device 101 may identify one or more frames in the video to be synthesized based on the execution of the slow shutter function among frames in the video. At least one of the handles 376-1 and 376-2 may be dragged on the visual object 374 by the user. The electronic device 101 may display a visual object 382 to store a result of synthesizing frames in the video selected by the handles 376-1 and 376-2. Based on an input indicating that the visual object 382 is selected, the electronic device 101 may synthesize the plurality of frames in the time section distinguished by the handles 376-1 and 376-2. As the frames are synthesized by the input to the visual object 382, a single image synthesized from the frames may be stored in the electronic device 101. The image stored in the electronic device 101 may be displayed in a form of a thumbnail in the portion 360. The electronic device 101 may receive an input to cancel synthesis of the frames based on the slow shutter function based on the visual object 384.

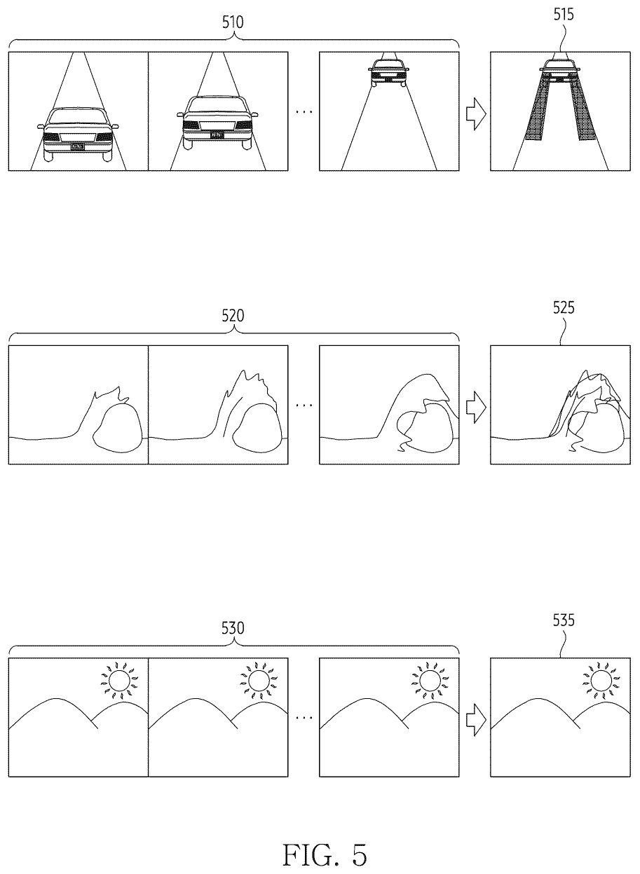

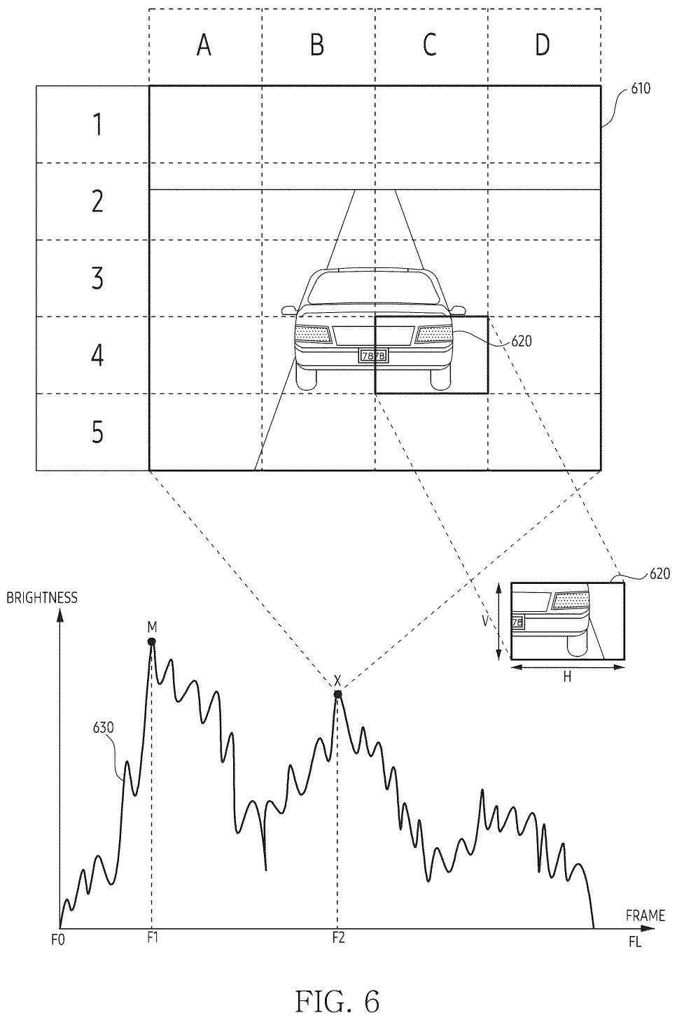

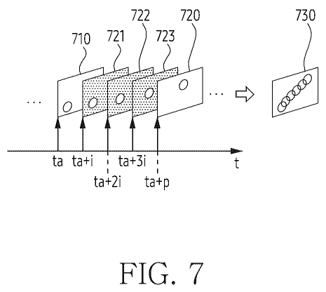

As described above, according to an embodiment, the electronic device 101 may execute one or more applications (e.g., the camera application, and/or the gallery application) to execute the slow shutter function. Based on the execution of the slow shutter function, by synthesizing the frames captured based on the distinct time sections spaced apart from each other, the electronic device 101 may obtain an image such as the single image captured based on a single opening of the aperture. In order to synthesize the plurality of frames, the electronic device 101 may select a synthesis mode to synthesize the plurality of frames, based on the visual object (e.g., the visual object representing the light source) included in the plurality of frames. An operation in which the electronic device 101 according to an embodiment selects one single synthesis mode among distinct synthesis modes, based on the visual object included in the plurality of frames will be described with reference to FIGS. 5 and 6. Each of the synthesis modes in which the electronic device 101 executes based on the slow shutter function will be described with reference to FIGS. 7 to 9, and/or 10A and 10B. For example, the synthesis modes may be distinguished by whether an additional frame is obtained based on interpolation, whether frames are sampled based on decimation, whether one function associated with the slow shutter function is performed, such as a directional filter, whether the colors included in the frames are simply combined, and/or whether the frames are synthesized based on weights corresponding to each of the frames.

Hereinafter, a structure of one or more hardware included in the electronic device 101 according to an embodiment will be described with reference to FIG. 4.

FIG. 4 is a block diagram of an electronic device 101 according to an embodiment of the disclosure. The electronic device 101 of FIG. 4 may include the electronic device 101 of FIGS. 1, 2, 3A, and 3B.

Referring to FIG. 4, according to an embodiment, the electronic device 101 may include at least one of a processor 120, memory 130, a display 310, or a camera 350. The processor 120, the memory 130, the display 310, and the camera 350 may be electronically and/or operably coupled with each other by an electronical component such as a communication bus 405. Hereinafter, that hardware is coupled operably may mean that a direct or an indirect connection between the hardware is established wired or wirelessly so that second hardware is controlled by first hardware among the hardware. Although illustrated based on distinct blocks, an embodiment is not limited thereto, and a portion (e.g., at least a portion of the processor 120 and the memory 130) of a hardware component illustrated in FIG. 4 may be included in a single integrated circuit such as a system on a chip (SoC). A type and/or the number of hardware components included in the electronic device 101 are not limited to those illustrated in FIG. 4. For example, the electronic device 101 may include only a portion of the hardware component illustrated in FIG. 4.

According to an embodiment, the processor 120 of the electronic device 101 may include a circuit to process data based on one or more instructions. For example, the circuit to process data may include an arithmetic and logic unit (ALU), a floating point unit (FPU), a field programmable gate array (FPGA), and/or a central processing unit (CPU). The number of the processors 120 may be one or more. For example, the processor 120 may have a structure of a multi-core processor such as a dual core, a quad core, or a hexa core. The processor 120 of FIG. 4 may include the processor 120 of FIG. 1.

The memory 130 of the electronic device 101 according to an embodiment may include a circuit to store data and/or an instruction inputted to and/or outputted from the processor 120. For example, the memory 130 may include volatile memory such as random-access memory (RAM) and/or non-volatile memory such as read-only memory (ROM). For example, the volatile memory may include at least one of dynamic RAM (DRAM), static RAM (SRAM), Cache RAM, and pseudo SRAM (PSRAM). For example, the non-volatile memory may include at least one of programmable ROM (PROM), erasable PROM (EPROM), electrically erasable PROM (EEPROM), flash memory, a hard disk, a compact disk, a solid state drive (SSD) and an embedded multimedia card (eMMC). The memory 130 of FIG. 4 may include the memory 130 of FIG. 1.

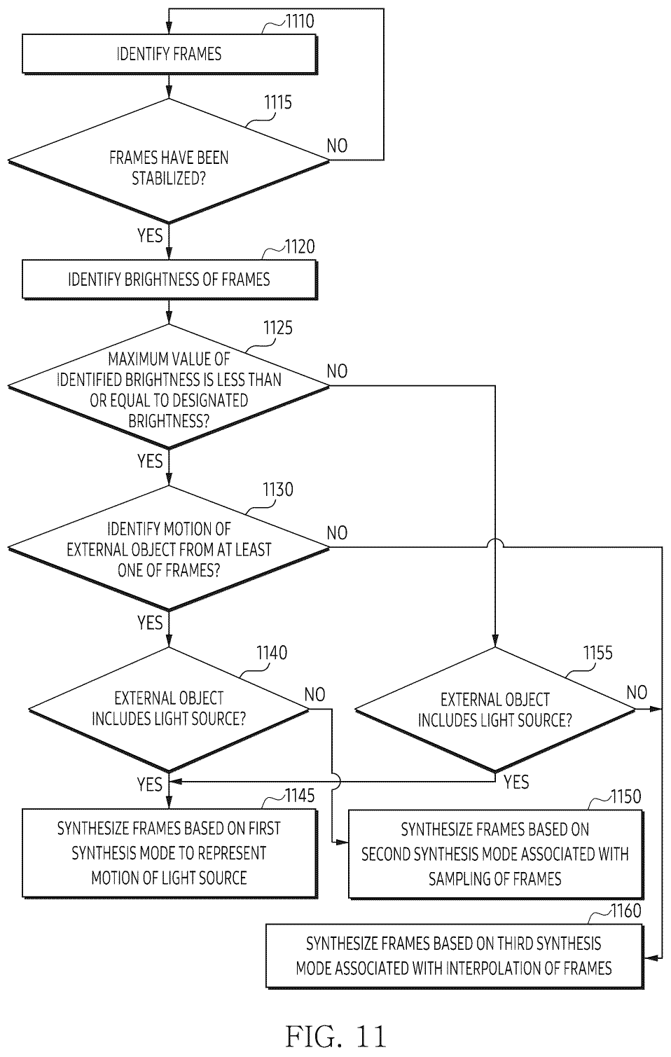

In the memory 130, one or more instructions (or commands) indicating calculation and/or an operation to be performed by the processor 120 on data may be stored. A set of one or more instructions may be referred to as firmware, an operating system, a process, a routine, a sub-routine and/or an application. For example, the electronic device 101 and/or the processor 120 may perform at least one of operations of FIGS. 11 to 13 when a set of a plurality of instructions distributed in a form of the operating system, the firmware, a driver, and/or the application is executed. Hereinafter, an installation of the application in the electronic device 101 may mean that one or more instructions provided in the form of the application are stored in the memory 130 of the electronic device 101 and the one or more applications are stored in an executable format (e.g., a file with an extension designated by the operating system of the electronic device 101) by the processor 120 of the electronic device 101. The application installed in the electronic device 101 may include an application to synthesize frames outputted from the camera 350, as in the state of FIG. 3A. The application installed in the electronic device 101 may include an application to synthesize frames corresponding to at least a portion of a video stored in the electronic device 101, as in the state of FIG. 3B.

The display 310 of the electronic device 101 according to an embodiment may output visualized information (e.g., at least one of the screens in the display 310 exemplified with reference to FIGS. 3A and 3B) to a user. For example, the display 310 may output the visualized information to the user, by being controlled by a controller such as the processor 120 and/or a graphic processing unit (GPU). The display 310 may include a flat panel display (FPD), and/or electronic paper. The FPD may include a liquid crystal display (LCD), a plasma display panel (PDP), and/or one or more light emitting diodes (LEDs). The LED may include an organic LED (OLED). The display 310 of the electronic device 101 according to an embodiment may include a sensor (e.g., a touch sensor panel (TSP)) to detect an external object (e.g., a finger of the user) on the display 310. For example, based on the TSP, the electronic device 101 may detect the external object that contacts with the display 310 or is floating on the display 310. In response to detecting the external object, the electronic device 101 may execute a function associated with a specific visual object corresponding to a location of the external object on the display 310 among the visual objects displayed in the display 310. The display 310 of FIG. 4 may include the display module 160 of FIG. 1.

The camera 350 of the electronic device 101 according to an embodiment may include one or more optical sensors (e.g., a charged coupled device (CCD) sensor, and a complementary metal oxide semiconductor (CMOS) sensor) generating an electrical signal indicating the color and/or brightness of light. A plurality of optical sensors included in the camera 350 may be disposed in a form of 2 dimensional array. The camera 350 may generate 2 dimensional data (e.g., a frame) corresponding to the light reaching the optical sensors of 2 dimensional array by substantially simultaneously obtaining electrical signals of each of the plurality of optical sensors. For example, photo data captured by using the camera 350 may mean a 2 dimensional frame data obtained from the camera 350. For example, video data captured by using the camera 350 may mean a sequence of a plurality of 2 dimensional frame data obtained from the camera 350. In an embodiment, the camera 350 may include a flash light and/or an infrared diode that emits light to an outside of the camera 350. A FoV of the camera 350 is an area formed based on a view angle in which a lens of the camera 350 may receive the light, and may correspond to an external space corresponding to an image generated by the camera 350.

The processor 120 of the electronic device 101 according to an embodiment may receive an input to synthesize frames obtained based on a first period. The input may be received in a state in which a slow shutter function is selected, such as a shooting input based on the visual object 324 of FIG. 3A. The input may include an input to execute the slow shutter function associated with the video stored in the electronic device 101, as described above based on the screen 305 of FIG. 3B. An operation in which the electronic device 101 synthesizes distinct frames based on the input to execute the slow shutter function will be described with reference to FIG. 5. The electronic device 101 may identify information indicating a motion included in at least one of the frames based on the input. The information may include a type (e.g., a designated type such as the light source) of a subject included by the frames, and/or locations at which the subject is captured in each of the frames. An operation in which the electronic device 101 according to an embodiment identifies the information on the frames will be described with reference to FIG. 6.

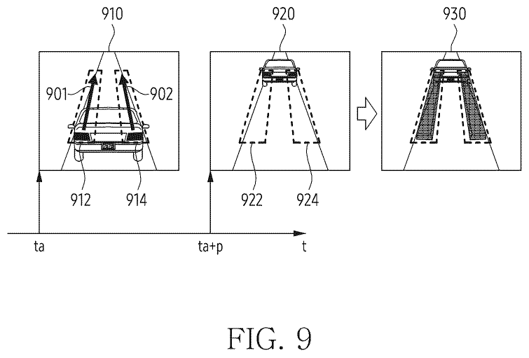

In an embodiment, the processor 120 of the electronic device 101 may obtain an image for the frames by synthesizing the frames based on a motion of at least one light source, based on identifying the at least one light source from at least one of the frames, based on the information. The electronic device 101 may synthesize the frames, based on a first designated synthesis mode in which the one or more light sources represent paths of the one or more light sources captured by the frames, based on identifying the one or more light sources from the frames. Based on the first designated synthesis mode, the electronic device 101 may synthesize the frames and other frames obtained based on interpolation. For example, based on the interpolation of the frames, the electronic device 101 may obtain the other frames, indicating locations of the one or more light sources at another time point between distinct time points in which the frames were captured. An operation in which the electronic device 101 obtains the other frames based on the interpolation of the frames will be described with reference to FIG. 7. An operation of applying a designated filter (e.g., a directional filter) to the frames in a state in which the electronic device 101 identifies at least one light source will be described with reference to FIG. 9.

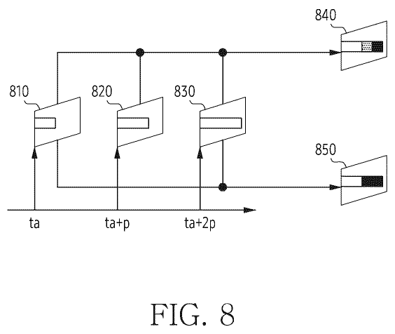

In an embodiment, the processor 120 of the electronic device 101 may obtain, based on identifying a motion of the external object distinct from the light source based on the information, an image with respect to the frames by synthesizing one or more frames sampled from the frames based on a second period longer than the first period. Sampling of the frames may be performed to lengthen the period of the frames to be used for synthesis, such as decimation. An operation in which the electronic device 101 synthesizes one or more sampled frames based on another period longer than the period of the frames, in a state of identifying that the light source is not included in the frames, will be described with reference to FIG. 8.

As described above, according to an embodiment, the electronic device 101 may synthesize the frames to support the slow shutter function. By synthesizing the frames discretely obtained based on a designated period, the electronic device 101 may obtain a second image substantially similar to a first image obtained using an open aperture during a period in which the frames are captured. Based on the second image, the electronic device 101 may support a long-exposure exceeding the designated period. Hereinafter, referring to FIG. 5, an operation in which the electronic device 101 according to an embodiment selects any one of distinct synthetic modes associated with the slow shutter function, based on a state of the frames will be described.

FIG. 5 illustrates an example of an operation in which an electronic device selects a synthesis mode to synthesize frames, according to an embodiment of the disclosure. The electronic device of FIG. 5 may be an example of the electronic device 101 of FIGS. 3A and 3B and/or 4.

Referring to FIG. 5, an operation in which the electronic device according to an embodiment performs synthesis for distinct groups (e.g., a first group 510 to a third group 530) of frames, based on execution of a slow shutter function is described. The frames included in the first group 510 to the third group 530 may be obtained from a camera (e.g., the camera 350 of FIG. 4), or included in distinct videos, based on distinct shooting inputs.

According to an embodiment, the electronic device may select any one of distinct synthetic modes to support the slow shutter function, based on scene analysis of frames. The scene analysis may include an operation of assigning any one of designated categories for selection of the synthesis mode to the group (e.g., the first group 510 to the third group 530) of frames to be synthesized by the slow shutter function. The designated categories may include a first category to classify a night time scene and a second category for classifying a daytime scene. Referring to FIG. 5, it is assumed that the electronic device classifies the frames of the first group 510 into the first category corresponding to the night time scene. It is assumed that the electronic device classifies the frames of a second group 520 to the third group 530 into the second category corresponding to the daytime scene. To improve performance of synthesizing the frames based on the slow shutter function, the electronic device may select a synthesis mode to be used for synthesizing the frames from among distinct synthesis modes, based on the category assigned to the group of the frames by the scene analysis.

In a state of synthesizing the frames of the first group 510 classified as the night time scene, the electronic device may identify whether a motion of at least one light source is included in the frames of the first group 510. In case that the motion of the at least one light source is included in the frames of the first group 510, the electronic device may obtain one or more other frames from the frames of the first group 510 based on interpolation of the frames of the first group 510. The electronic device may obtain an image 515 corresponding to the frames of the first group 510, based on the synthesis of the frames of the first group 510 and the one or more other frames.

In an embodiment, the frames of the first group 510 and the one or more other frames may be synthesized based on an addition calculation on pixels included in the frames. Based on the addition calculation, a pixel of the image 515 may include a parameter that combines parameters (e.g., brightness of red, blue, and green to indicate a color based on a RGB color space) of pixels of each of the frames. The electronic device may store the image 515 in memory (e.g., the memory 130 of FIG. 4) as a result of applying the slow shutter function to the frames of the first group 510. Since the electronic device synthesizes the one or more other frames obtained based on the interpolation of the frames of the first group 510 with the frames of the first group 510, the image 515 may represent the motion of the at least one light source that is not captured by the frames of the first group 510.

In a state of synthesizing the frames (e.g., the frames of the second group 520 and/or the frames of the third group 530) classified as the daytime scene, the electronic device may select the synthesis mode to be used for synthesizing the frames based on a motion of an external object included in the frames. Similarly, in a state of synthesizing frames, which is classified as the night time scene and does not include any light source, the electronic device may determine the synthesis mode to be used for synthesizing the frames, based on the motion of the external object included in the frames. Referring to FIG. 5, the electronic device may identify that the frames of the second group 520 include an irregular motion (e.g., fluid flow) such as a wave, based on the scene analysis of the frames of the second group 520. In the state of identifying the motion of the external object (e.g., the wave) distinct from the light source from the frames of the second group 520, the electronic device may sample m frames less than N frames from the N frames of the second group 520, based on sampling (e.g., decimation) of the frames of the second group 520.

The electronic device may obtain an image 525 corresponding to the frames of the second group 520 by synthesizing the sampled m frames. Synthesizing the m frames by the electronic device may be performed based on an average calculation and/or a weighted sum calculation. Based on the average calculation, a pixel in the image 525 may have a parameter indicating an average of parameters of pixels included in the m frames. Based on the weighted sum calculation, the pixel in the image 525 may have a parameter in which weights corresponding to each of the m frames are combined with parameters of the pixels included in the m frames. The electronic device may store the image 525 in the memory of the electronic device as a result of synthesizing the frames of the second group 520.

Referring to FIG. 5, the electronic device may identify that the frames of the third group 530 do not include any motion, based on the scene analysis of the frames of the third group 530. In a state of synthesizing the frames of the static third group 530 that does not include any motion, the electronic device may synthesize the frames of the third group 530 based on the interpolation. The electronic device may obtain, from the frames of the third group 530, other frames at other time points between distinct time points at which the frames of the third group 530 are captured. The electronic device may obtain an image 535 for the frames of the third group 530 by synthesizing the frames of the third group 530 and the obtained other frames. Synthesizing the frames of the third group 530 and the other frames by the electronic device may be performed based on the average calculation and/or the weighted sum calculation, described above, based on the frames of the second group 520.

As described above, according to an embodiment, the electronic device may select any one of the distinct synthesis modes supported by the slow shutter function, based on the scene analysis of frames. In a first state of synthesizing the frames (e.g., the frames of the first group 510) classified as the night time scene and including at least one light source, the electronic device may obtain additional frames to be synthesized with the frames based on a preprocessing operation including the interpolation. In the first state, the electronic device may synthesize the frames and the additional frames based on the addition calculation. In a second state that is distinct from the first state and identifies the motion of the external object distinct from the light source, the electronic device may selectively synthesize a portion of the frames, based on the preprocessing operation including the sampling (e.g., the decimation). In the second state, the electronic device may synthesize the portion of the frames, based on the average calculation and/or the weighted sum calculation. In a third state (e.g., a state in which the frames do not include any motion) distinct from the first state to the second state, the electronic device may obtain additional frames to be synthesized together with the frames, based on the interpolation. In the third state, the electronic device may synthesize the frames and the additional frames, based on the average calculation and/or the weighted sum calculation.

Hereinafter, a first designated synthesis mode to synthesize the frames based on the slow shutter function may include an operation performed by the electronic device to synthesize the frames of the first group 510. For example, the first designated synthesis mode may include obtaining additional frames based on the interpolation of the frames and synthesizing the frames and the additional frames, based on the addition calculation. Hereinafter, a second designated synthesis mode to synthesize the frames based on the slow shutter function may include an operation performed by the electronic device to synthesize the frames of the second group 520. For example, the second designated synthesis mode may include selecting M frames less than N frames from the N frames, and synthesizing the M frames based on the average calculation and/or the weighted sum calculation. Hereinafter, a third designated synthesis mode to synthesize the frames based on the slow shutter function may include an operation performed by the electronic device to synthesize the frames of the third group 530. For example, the third designated synthesis mode may include obtaining additional frames based on the interpolation of the frames, and synthesizing the frames and the additional frames based on the average calculation and/or the weighted sum calculation.

As described above, the electronic device may perform the scene analysis on the frames to select the synthesis mode based on image processing for the frames. The image processing may be performed based on software to simulate a biological neural network, such as a neural network, hardware (e.g., the processor 120 of FIG. 4 including a CPU, a GPU, and/or a neural processing unit (NPU)) in an electronic device executing the software, or a combination thereof. The image processing may include obtaining distinct parameters corresponding to areas formed in the frames and having a designated size. Since the electronic device selects the synthesis mode using the scene analysis, the electronic device may adaptively synthesize the image corresponding to the purpose of the slow shutter function, based on the category of the scene included in the frames.

Hereinafter, an example of an operation in which the electronic device according to an embodiment performs the scene analysis on the frames will be described with reference to FIG. 6.

FIG. 6 illustrates an example of an operation in which an electronic device identifies brightness of each of frames, according to an embodiment of the disclosure. The electronic device of FIG. 6 may be an example of the electronic device 101 of FIGS. 3A and 3B, and/or 4. Hereinafter, an operation in which the electronic device executes a slow shutter function, based on one group of a plurality of frames including a frame 610 will be described.

According to an embodiment, the electronic device may identify brightness of the frame 610 in response to a request to synthesize the plurality of frames including the frame 610 based on the slow shutter function. The request may include an interaction of the electronic device 101 and a user described above with reference to FIGS. 3A and/or 3B. The electronic device may obtain information indicating the brightness of the frame 610 based on distinct areas formed on the frame 610. Although the operation of the electronic device to identify the brightness of one frame 610 of the plurality of frames is described, an embodiment is not limited thereto. For example, the electronic device may identify the brightness of at least a portion of the plurality of frames. The brightness may indicate a combination and/or an average of distinct parameters (e.g., respective strength of red, blue, and green) to indicate the color of pixels.

In an embodiment, the electronic device may select a synthesis mode to be used to synthesize the frames, based on a parameter associated with the brightness of at least one of the frames. The parameter may include a representative value of the brightness and/or the color of at least one of the frames. The representative value may be an average value, a maximum value, a minimum value, a difference, a deviation, or a combination thereof of brightness and/or colors of each of pixels included in at least one (e.g., the frame 610) of the frames. An embodiment is not limited thereto, and the representative value may be determined based on pixels in a relatively dark area among the pixels included in at least one of the frames to identify whether a group of the frames corresponds to a night time scene. The parameter may include a state (e.g., shutter speed) of a camera capturing at least one of the frames.

A graph 630 of FIG. 6 illustrates an example of parameters of each of the plurality of frames in which the electronic device includes the frame 610. In case that the parameters for all frames included in the group are identified, as illustrated in the graph 630, the electronic device may classify the group among designated categories, based on a maximum value M among the parameters. The electronic device may classify the group among the designated categories, based on at least one parameter corresponding to at least one frame corresponding to a designated number and/or a designated time section in the group. For example, in case of identifying that the maximum value M of the parameters is less than or equal to a designated threshold, or identifying that the frames were obtained based on a shutter speed corresponding to a period greater than a designated period (e.g., 1/30 millisecond), the electronic device may classify the group of frames into a first designated category associated with the night time scene. Based on the first designated category, the electronic device may synthesize the group based on a first designated synthesis mode or a third designated synthesis mode. In the example, in case of identifying that the maximum value M of the parameters is more than or equal to the designated threshold, or identifying that the frames were obtained based on the shutter speed corresponding to a period less than the designated period, the electronic device may classify the group of the frames into a second designated category associated with a daytime scene. Based on the second designated category, the electronic device may synthesize the group based on a second designated synthesis mode or a third designated synthesis mode.

According to an embodiment, the electronic device may obtain information associated with the brightness of the frame 610, based on the distinct areas (and/or blocks) formed in the frame 610. The electronic device may obtain the information based on the areas, based on that the group of the frames including the frame 610 is classified into the first designated state associated with the night time scene. The area may be referred to as a group of the pixels included in the frame 610. Referring to FIG. 6, twenty areas formed in the frame 610 are illustrated. A size of the area may be proportional to a size of the frame 610, or may be set to designated values. Width H of each of areas of FIG. 6 may correspond to ¼ of the width of the frame 610, and height V of each of the areas may correspond to ⅕ of the height of the frame 610. Referring to FIG. 6, for convenience of description, the areas may be referenced, based on alphabets (e.g., A to D) assigned along a horizontal direction parallel to the width of the frame 610 and numbers (e.g., 1 to 5) assigned along a vertical direction parallel to the height of the frame 610. For example, an area 620 that matches C among the alphabets along the vertical direction and matches 3 among the numbers along the horizontal direction may be referred to as an area C3.

Referring to FIG. 6, the electronic device may identify at least one light source included in the frame 610 and/or a motion of the at least one light source, based on the areas to distinguish the frame 610. For example, in order to identify at least one light source included in the area 620 in the frame 610, the electronic device may obtain information associated with the brightness of the area 620. The information may include the representative value (e.g., an average value, a maximum value, a minimum value, and/or a deviation of the brightness) of the brightness of the pixels included in the area 620. The information may include the deviation between the brightness of the pixels in the area 620. The deviation may include a difference the between brightness of two pixels adjacent along a horizontal direction and/or a vertical direction among the pixels. For example, the electronic device may obtain the deviation between the brightness by performing partial differential calculation on the brightness of pixels in the area 620. The deviation included in the information may be used to distinguish a portion where the light source is captured in the area 620, and another portion distinct from the portion. For example, the deviation may indicate reliability to identify the light source based on the representative value of the brightness of the pixels in the area 620.

According to an embodiment, the electronic device may identify whether at least one light source is included in the area 620 based on the information associated with the brightness of the area 620. In case that the representative value of the brightness of pixels included in the area 620 is greater than the designated threshold, the electronic device may determine that at least one light source is included in the area 620. In an embodiment, in case that the number of pixels having the brightness greater than the designated threshold among the pixels included in the area 620 is greater than the designated threshold, the electronic device may determine that at least one light source is included in the area 620. Similar to the above-described operation based on the area 620, the electronic device may identify at least one light source from other areas in the frame 610 distinguished from the area 620. Referring to FIG. 6, the electronic device may identify at least one light source from an B4 area and an C4 area in the frame 610. For example, the electronic device may identify at least one visual object representing the light source from the B4 area and the C4 area in the frame 610.

According to an embodiment, in case that the electronic device identifies the visual object for the light source based on areas formed in each of the frames, such as the B4 area and the C4 area of the frame 610, the electronic device may synthesize the frames based on the first designated synthesis mode associated with the interpolation. To synthesize the frames, the electronic device may identify the motion of the at least one light source captured by the frames, by comparing the frame 610 with another frame adjacent to the frame 610. The electronic device may adjust the number of other frames to be additionally obtained from the frames based on the interpolation, based on a size at which a location of the at least one light source in the frames is changed. In case that the location of the at least one light source in the frames is not changed, or in case that the frames are substantially similar and do not include any motion, the electronic device may synthesize the frames based on another synthesis mode (e.g., the third designated synthesis mode) distinct from the first designated synthesis mode.

The operation in which the electronic device identifies the light source from the group of frames including the frame 610 is not limited to image processing based on the distinct areas (e.g., the area 620) formed within the frame 610 described above with reference to FIG. 6. According to an embodiment, the electronic device may identify a type of a subject included in the frame 610 based on a neural network trained to recognize the subject included in the frame 610. Based on the neural network, in response to identifying a designated type of subject associated with the light source from the frame 610, the electronic device may determine the synthesis mode to synthesize the group as the first designated synthesis mode.

As described above, the electronic device according to an embodiment may perform scene analysis on the group in a state of synthesizing the group of frames including the frame 610 based on the slow shutter function. As illustrated in the graph 630, based on the brightness of the pixels included in the frames included in the group, the electronic device may identify whether the group is classified into the designated category associated with the night time scene. In case that the group is classified into the designated category, the electronic device may identify at least one light source from the frames, based on areas formed in the frames. In an embodiment, a result of performing the scene analysis on the group of the frames and/or a result of identifying at least one light source may be stored in metadata associated with the group. For example, the electronic device that obtained a video including the frames based on a shooting input may store the category in which the frames are classified and/or whether the frames include the visual object associated with the light source in metadata corresponding to the video. In a state of synthesizing the frames in the video based on the slow shutter function, the electronic device may identify at least one light source captured by the frames based on the metadata.

Hereinafter, an example of an operation in which the electronic device according to an embodiment performs the interpolation commonly included in the first synthesis mode and/or the third synthesis mode will be described with reference to FIG. 7.

FIG. 7 illustrates an example of an operation in which an electronic device synthesizes frames 710 and 720 based on interpolation of the frames 710 and 720, according to an embodiment of the disclosure. The electronic device of FIG. 7 may be an example of the electronic device 101 of FIGS. 3A and 3B, and/or 4. For example, in response to an input indicating that the frames 710 and 720 are synthesized based on a slow shutter function, the electronic device may identify a category for the frames 710 and 720, and/or the number of light sources included in the frames 710 and 720. In case that the frames 710 and 720 are classified into a designated category associated with a night time scene, and/or in case that the frames 710 and 720 identify one or more light sources, the electronic device may synthesize the frames 710 and 720, based on a synthesis mode (e.g., a first synthesis mode, and/or a third synthesis mode) associated with the interpolation. Although the operation of the electronic device based on the two frames 710 and 720 is described, the number of the frames that the electronic device may synthesize based on the slow shutter function is not limited to an embodiment of FIG. 7.

Referring to FIG. 7, time points ta and ta+p at which the frames 710 and 720 are captured are illustrated based on a time axis. The frame 710 may be captured earlier than the frame 720 based on a camera (e.g., the camera 350 of FIG. 3A) of the electronic device. According to an embodiment, the electronic device may obtain the frames 710 and 720, using the camera that obtains data from an image sensor based on a period p. A frame rate of the camera may be a reciprocal Up of the period p. In case that the category of the frames 710 and 720 corresponds to the designated category associated with the night time scene, the electronic device may obtain frames 721, 722, and 723 distinct from the frames 710 and 720 based on the interpolation of the frames 710 and 720. The other frames 721, 722, and 723 may be referred to as a virtual frame in terms of the virtual frame obtained from a real frame.

The electronic device may perform the interpolation on the frames 710 and 720, based on a period i less than the period p. For example, a frame rate (e.g., 1/i) of the frames 721, 722, and 723 may be greater than a frame rate (e.g., 1/p) of the frames 710 and 720. The electronic device may obtain the period i associated with the interpolation of the frames 710 and 720, based on a motion of the light source captured by the frames 710 and 720. For example, the frame rate of the frames 721, 722, and 723 may be proportional to a distance between locations of the light source included in the frames 710 and 720. The frame rate (e.g., 1/i) associated with the interpolation of the frames 710 and 720 may be referred to as an interpolation rate. Referring to FIG. 7, the electronic device may obtain the interpolation rate (e.g., 1/i=4/p) of the frames, based on a multiple of the frame rate of the frames 710 and 720. For example, in case that the frame rate is 30 frame per second (fps), the interpolation rate may be 120 fps. The multiple applied to the frame rate may be associated with a path and/or a moving distance of the light source identified by the electronic device from the frames 710 and 720. Based on the interpolation for the frames 710 and 720, the electronic device may obtain the frames 721, 722, and 723 corresponding to one or more second time points (e.g., a time point ta+i, a time point ta+2i, and a time point ta+3i) between first time points (e.g., the time point ta and the time point ta+p) at which the frames 710 and 720 are captured. For example, the electronic device may identify the locations of the light source at the one or more second time points, based on the locations of the light source at the first time points identified by the frames 710 and 720. Based on the identified locations, the electronic device may obtain the frames 721, 722, and 723.

In an embodiment of obtaining a virtual frame (e.g., the frames 721, 722, and 723) based on the interpolation of the frames 710 and 720, the electronic device may set another area in the virtual frame distinct from a specific area corresponding to the light source to a designated color (e.g., black). The designated color may indicate that a pixel to which the designated color is assigned is excluded from the synthesis of the frames. For example, the frames 721, 722, and 723 may selectively include locations of the light source of each of the time points ta+i, ta+2i, and ta+3i corresponding to the frames 721, 722, and 723 among information indicated by the frames 710 and 720. Since the frames 721, 722, and 723 selectively include the locations of the light source, an external object distinct from the light source in the frames 710 and 720 may not be included in the frames 721, 722, and 723. An embodiment is not limited thereto, and the virtual frame such as the frames 721, 722, and 723 may include an external object distinct from the light source in the frames 710 and 720.

The electronic device that obtained one or more the virtual frames (e.g., the frames 721, 722, and 723) based on the interpolation of the frames 710 and 720 may obtain a single image 730 by synthesizing the frames 710 and 720 and the one or more virtual frames. The synthesis of the frames 710, 720, 721, 722, and 723 may be performed based on an addition calculation of parameters indicating brightness and/or colors of pixels included in the frames 710, 720, 721, 722, and 723. The calculation used for synthesizing the frames 710, 720, 721, 722, and 723 is not limited to the addition calculation. For example, in the third designated synthesis mode distinct from the first designated synthesis mode synthesizing the frames 710, 720, 721, 722, and 723 based on the addition calculation, the electronic device may synthesize the frames 710, 720, 721, 722, and 723, based on a weighted sum calculation and/or an average calculation based on weights assigned to the frames 710, 720, 721, 722, and 723.

Referring to FIG. 7, since the additional frames 721, 722, and 723 are used for synthesizing the frames 710 and 720 based on the interpolation of frames 710 and 720, the single image 730 may represent movement of the light source based on other locations between the locations of the light source included in the frames 710 and 720. For example, based on identifying at least one light source from the frames 710 and 720, the electronic device may synthesize the frames 710, 720, 721, 722, and 723 to obtain the image 730 representing a path in which the at least one light source was continuously moved. For example, based on the image 730, the electronic device may provide a user experience similar to capturing a single image based on a long-exposure from the discretely obtained frames 710 and 720. Using the one or more virtual frames (e.g., the frames 721, 722, and 723) obtained based on the interpolation of the frames 710 and 720, the electronic device may support generation of the image 730 based on the long-exposure, even though a camera discretely outputs frames based on a periodic reset.

According to an embodiment, the electronic device may perform the synthesis based on sampling of the frames 710 and 720 in another state distinct from a state in which at least one light source is identified from the frames 710 and 720. Hereinafter, an operation of the electronic device to synthesize the frames in the other state will be described with reference to FIG. 8.

FIG. 8 illustrates an example of an operation in which an electronic device synthesizes frames based on sampling of the frames, according to an embodiment of the disclosure. The electronic device of FIG. 8 may be an example of the electronic device 101 of FIGS. 3A and 3B, and/or 4. For example, in response to an input indicating that frames 810, 820, and 830 are synthesized based on a slow shutter function, the electronic device may identify a category for the frames 810, 820, and 830 and/or the number of light sources included in the frames 810, 820, and 830. In case that the frames 810, 820, and 830 are classified into another category (e.g., a category associated with a daytime scene) distinct from a designated category associated with a night time scene, and/or in case that no light source is identified from the frames 810, 820, and 830, the electronic device may synthesize the frames 810, 820, and 830 based on a synthesis mode (e.g., a second synthesis mode) associated with sampling. Although the operation of the electronic device based on the three frames 810, 820, and 830 is described, the number of the frames that the electronic device may synthesize based on the slow shutter function is not limited to an embodiment of FIG. 8.

Referring to FIG. 8, time points ta, ta+p, and ta+2p at which the frames 810, 820, and 830 are captured are illustrated based on a time axis. The electronic device may obtain the frames 810, 820, and 830 based on a camera controlled based on a frame rate of 1/p. Based on an input indicating that the frames 810, 820, and 830 are synthesized based on the slow shutter function, the electronic device may obtain information associated with brightness of at least one of the frames 810, 820, and 830. As described above with reference to FIG. 6, the information may be obtained based on areas formed in each of the frames 810, 820, and 830. The electronic device may sample the frames 810, 820, and 830 based on a second period 2p longer than a first period p in which the frames 810, 820, and 830 are captured in another state distinct from a state in which the light source is identified from the frames 810, 820, and 830. Referring to FIG. 8, the electronic device may select the frames 810 and 830 among the frames 810, 820, and 830 by performing the sampling based on the second period 2p. The electronic device may obtain an image 850 corresponding to the input by synthesizing the sampled frames based on the second period 2p.

Sampling at least one of the frames 810, 820, and 830 based on the second period 2p by the electronic device may be referred to as frame decimation in terms of a decrease in the number of the frames used for the synthesis. Based on the frame decimation, the electronic device may reduce a frame rate used for synthesizing the frames 810, 820, and 830 to less than a frame rate of the frames 810, 820, and 830. In an embodiment of FIG. 8, in which the frame decimation based on the second period 2p, which is twice the first period p in which the frames 810, 820, and 830 are captured is performed, the electronic device may obtain the image 850 synthesized according to a frame rate that is half of the frame rate of the frames 810, 820, and 830. Referring to FIG. 8, an image 840 synthesized based on the frame rate of the frames 810, 820, and 830 is illustrated. Since the frames 810 and 830 less than the number of the frames 810, 820, and 830 are used for synthesizing the image 850, the electronic device may obtain the image 850, based on another period shorter than the period for obtaining the image 840 by synthesizing the frames 810, 820, and 830. For example, based on the frame decimation, the electronic device may increase speed at which the frames 810, 820, and 830 are synthesized and/or reduce the amount of calculation.

In an embodiment of partially synthesizing the frames 810, 820, and 830 based on the sampling, the electronic device may synthesize a sampled portion (e.g., the frames 810 and 830) of the frames 810, 820, and 830 based on a weighted sum calculation and/or an average calculation. Weights (e.g., weights assigned to each of the frames 810 and 830) used in the weighted sum calculation may be adjusted based on a motion of a subject captured by the frames 810, 820, and 830. The weights may be adjusted by the electronic device for blurring the motion of the subject represented by the image 850.

As described above, the electronic device according to an embodiment may obtain the single image 850 representing the motion of at least one subject included in the frames 810, 820, and 830 in the period in which the frames 810, 820, and 830 are captured based on the sampling of the frames 810, 820, and 830. The image 850 may represent the motion of the subject disposed at distinct locations in the frames 810, 820, and 830, based on a visual effect such as blur. Based on the sampling, the electronic device may synthesize at least one of the frames 810, 820, and 830 relatively quickly based on the relatively small amount of calculation.

The operation of synthesizing the frames 810, 820, and 830 by the electronic device is not limited to the above-described interpolation and/or the frame decimation. Hereinafter, an operation in which the electronic device synthesizes the frames based on a directional filter will be described with reference to FIG. 9.

FIG. 9 illustrates an example of an operation in which an electronic device synthesizes frames 910 and 920 based on a motion of a light source captured by the frames 910 and 920, according to an embodiment of the disclosure. The electronic device of FIG. 9 may be an example of the electronic device 101 of FIGS. 3A and 3B, and/or 4. For example, the electronic device may obtain information associated with brightness of the frames 910 and 920 in response to an input indicating that the frames 910 and 920 are synthesized based on a slow shutter function. Based on the information, the electronic device may identify locations of one or more light sources included in the frames 910 and 920. Referring to FIG. 9, an example of the frames 910 and 920 captured at distinct time points ta and ta+p, and including taillights of a vehicle is illustrated. The electronic device may identify light sources (e.g., the taillights of the vehicle) included in the frames 910 and 920 based on scene analysis of the frames 910 and 920. For example, the electronic device may identify locations of the light sources included in each of the frames 910 and 920.

Based on identifying a visual object corresponding to the light source from the frames 910 and 920, the electronic device may obtain information associated with a path of the visual object captured by the frames 910 and 920. For example, the electronic device may identify two light sources moving along directions 901 and 902 in the frames 910 and 920, by comparing the frames 910 and 920. The information may indicate a directional filter included in the frames 910 and 920, and to be applied to at least one visual object corresponding to the light source. Based on the directional filter, the electronic device may blurrily extend the color of a specific portion of the frame to another portion distinct from the specific portion along a specific direction. The information may include a location and/or a size (e.g., a size of a kernel of the directional filter) of the directional filter to be applied to each of the frames 910 and 920.

In an embodiment of FIG. 9 identifying two light sources moving along the directions 901 and 902 from the frames 910 and 920, the electronic device may obtain the information associated with the directional filter to be applied to each of the frames 910 and 920, based on the motion of the two light sources indicated by the frames 910 and 920. For example, the directional filter to be applied to the frame 910 may be set to blurrily extend the two light sources included at the bottom of areas 912 and 914 in each of the areas 912 and 914, with a direction corresponding to the areas 912, 914, and/or a kernel size. For example, the directional filter to be applied to the frame 920 may be set to blurrily extend the two light sources included at the top of the areas 922 and 924 in each of the areas 922 and 924, with the kernel size corresponding to the areas 922 and 924. The kernel size may be adjusted based on a size of the motion (e.g., the motion of the two light sources) of the external object identified based on comparison of the frames 910 and 920. For example, the electronic device may adjust the kernel size of the directional filter by comparing distinct thresholds and the size of the motion as illustrated in Table 1.

TABLE 1

| | kernel size of directional | |
|---|---|---|
| size of motion | filter | interpolation multiple |
| 0~Th1 | 3 × 3 | 2× |
| Th1~Th2 | 5 × 5 | 4× |
| Th2~Th3 | 7 × 7 | 8× |
| Th3~ | 9 × 9, 11 × 11 | 8× |

Referring to Table 1, as the size of the motion identified from the frame increases, the kernel size of the directional filter applied to the frame may gradually increase. The interpolation multiple in Table 1 may mean the interpolation multiple having the same effect as the directional filter corresponding to the kernel size. For example, in case that the size of the motion of the two light sources identified from the frames 910 and 920 has a size between a threshold Th1 to a threshold Th2, the electronic device may apply the directional filter with the kernel size of 5×5 to each of the frames 910 and 920. The image synthesized from the frames 910 and 920 to which the directional filter is applied may be substantially similar to the image in which the frames 910 and 920 and other frames obtained by the interpolation having another frame rate that is four times the frame rate of the frames 910 and 920 are synthesized. Referring to FIG. 9, a single image 930 obtained by applying the directional filter to the frames 910 and 920 by the electronic device according to an embodiment is illustrated. For example, the electronic device may obtain the image 930 by synthesizing the frames 910 and 920 changed based on the directional filter. Based on the synthesis of the frames 910 and 920, the electronic device may obtain the image 930 in which paths of the visual object corresponding to the two light sources are represented in the frames 910 and 920. Based on the image 930, the electronic device may represent the path of the light sources moved between the time points at which the frames 910 and 920 are captured. For example, the electronic device may compensate for spacing of each of the light sources discretely captured by the frames 910 and 920 based on the directional filter.

As described above, according to an embodiment, the electronic device may obtain the image 930 in which the path of the light sources included in the frames 910 and 920 are represented, based on the frames 910 and 920 changed by the directional filter and/or the interpolation of the changed frames 910 and 920. Since the electronic device performs the synthesis of the frames 910 and 920 based on the slow shutter function based on the directional filter, the electronic device may obtain the image 930 to which a visual effect similar to a capture based on a long-exposure is applied. For example, using a camera that does not support the long-exposure, the electronic device may obtain the image 930 to which the effect similar to the long-exposure is applied.

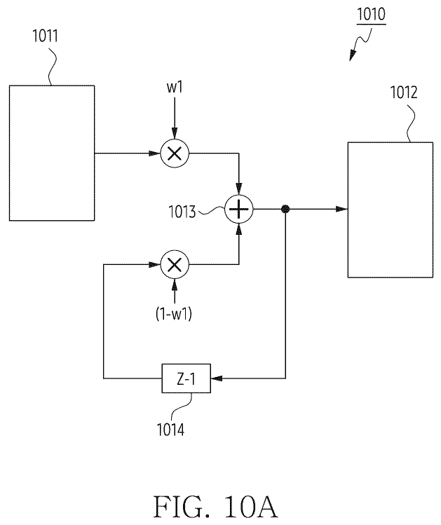

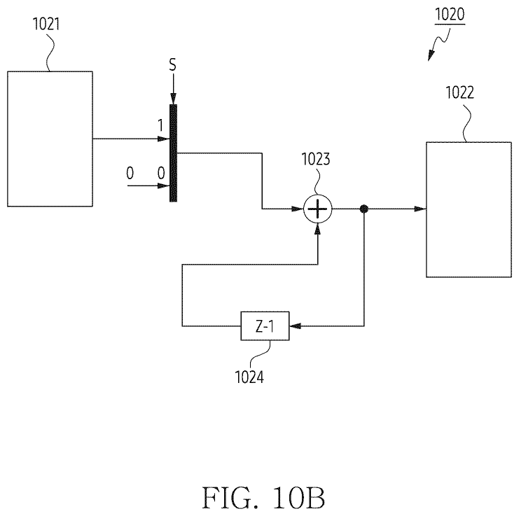

Hereinafter, an example of an operation in which the electronic device according to an embodiment combines pixels of distinct frames will be described with reference to FIGS. 10A and 10B.

FIGS. 10A and 10B illustrate signal flowcharts 1010 and 1020 to synthesize frames by an electronic device according to various embodiments of the disclosure. The electronic device of FIGS. 10A and 10B may be an example of the electronic device 101 of FIGS. 3A and 3B, and/or 4. The electronic device may obtain the frames to be inputted to any one of the signal flowcharts 1010 and 1020, based on interpolation and/or sampling (e.g., frame decimation) associated with a slow shutter function. The signal flowchart 1010 of FIG. 10A may indicate a weighted sum calculation of the frames performed by the electronic device. The signal flowchart 1020 of FIG. 10B may indicate an addition calculation of the frames performed by the electronic device. The signal flowcharts 1010 and 1020 of FIGS. 10A and 10B illustrate synthesizing the frames, based on an application executed by a processor (e.g., the processor 120 of FIG. 4) of the electronic device 101.

Referring to FIG. 10A, in a state of performing the weighted sum calculation of the frames, the electronic device may sequentially synthesize the frames based on the signal flowchart 1010. For example, the electronic device may apply a weight w1 assigned to a specific frame to information 1011 indicating color of a pixel included in the specific frame. The electronic device may obtain information 1012 by combining the information 1011 to which the weight w1 is applied with other information, based on an adder 1013. The other information may include the information 1012, delayed by delay conversion 1014, to which another weight (e.g., 1-w1) distinct from the weight w1 is applied. In a state in which a plurality of frames is sequentially inputted into the signal flowchart 1010, the information 1012 delayed by the delay conversion 1014 may indicate the information 1012 outputted from the signal flowchart 1010 before the specific frame is inputted. For example, the information 1012 delayed by the delay conversion 1014 may include a weighted sum of the pixels of one or more other frames combined by the signal flowchart 1010 before the specific frame is inputted.

Referring to FIG. 10B, in a state of performing the addition calculation of the frames, the electronic device may sequentially synthesize the frames based on the signal flowchart 1020. For example, the electronic device may filter information 1021 indicating the color of the pixel included in the specific frame based on a parameter s indicating whether the pixel corresponds to a light source. In case that the pixel corresponds to the light source, the electronic device may obtain information 1022 by combining the information 1021 with other information based on an adder 1023. The other information may be inputted to the adder 1023 based on delay conversion 1024 at a time point when the information 1021 is inputted, as the information 1022 outputted from the signal flowchart 1020 before the information 1021 is inputted to the signal flowchart 1020. Based on the signal flowchart 1020, the colors of the pixels included in the distinct frames and representing the light source may be accumulated in the information 1022. For example, the information 1022 may indicate a pixel of a single image (e.g., the image 515 of FIG. 5) in which locations and/or the colors of the pixels included in the distinct frames are combined.

FIG. 11 illustrates an example of a flowchart to describe an operation performed by an electronic device according to an embodiment of the disclosure. The electronic device of FIG. 11 may be an example of the electronic device 101 of FIGS. 3A and 3B, and/or 4. For example, at least one of operations of FIG. 11 may be performed by the electronic device 101 of FIG. 4 and/or the processor 120 of FIG. 4.

Referring to FIG. 11, in operation 1110, the electronic device according to an embodiment may identify frames. The electronic device may identify the frames of the operation 1110 in response to an input associated with a slow shutter function. The input may include a shooting input described above with reference to FIG. 3A. In response to the shooting input, the electronic device may identify the frames from a camera (e.g., the camera 350 of FIG. 3A) based on a time section associated with the shooting input. The time section may be associated with a time point at which the shooting input is received. For example, a beginning moment of the time section may correspond to the time point at which the shooting input is received. The input associated with the slow shutter function may include the input (e.g., the input indicating that a visual object 382 is selected) described above with reference to FIG. 3B. In response to the input, the electronic device may identify the frames included in the time section selected by a user in a video.

Referring to FIG. 11, in operation 1115, according to an embodiment, the electronic device may identify whether the frames identified by the operation 1110 have been stabilized. In case that the electronic device identifies the frames from the camera, the electronic device may identify whether the frames have been stabilized based on data of an image stabilizer (e.g., the image stabilizer 240 of FIG. 2) included in the camera. In case that the electronic device identifies the frames included in the video, the electronic device may identify whether the frames have been stabilized based on a motion of one or more subjects included in the frames. Stabilization of the frames may be associated with vibration of the camera and/or an irregular motion at the time point that the frames are captured. For example, in case that the vibration of the camera is identified to be less than a designated size, the electronic device may determine that the frames are stabilized. Before the frames are stabilized (1115-NO), the electronic device may perform the operation 1110 again to identify the frames again. For example, in case that the electronic device identifies the frames from the camera, the electronic device may repeatedly perform identification of the frames based on the operation 1110 until the frames are stabilized.

In a state in which the frames are stabilized (1115-YES), in operation 1120, according to an embodiment, the electronic device may identify brightness of the frames. As illustrated in the graph 630 of FIG. 6, the electronic device may identify a representative value of the brightness of each of the frames. In operation 1125, according to an embodiment, the electronic device may determine whether a maximum value of the identified brightness is less than or equal to a designated brightness based on the operation 1120. The electronic device may obtain the maximum value based on the brightness of a portion of the frames. The designated brightness may be set to classify the frames identified based on the operation 1110 into a designated category associated with a night time scene. The designated brightness may be heuristically set based on the distinct frames associated with the night time scene.

In a state in which the maximum value of the brightness identified based on the operation 1120 is less than or equal to the designated brightness (1120-YES), in operation 1130, according to an embodiment, the electronic device may identify a motion of an external object from at least one of the frames. In case that the maximum value of the brightness identified based on the operation 1120 is less than or equal to the designated brightness, the electronic device may classify the frames of the operation 1110 into the designated category associated with the night time scene. The external object may be referred to as a subject included in at least one of the frames. The motion of the external object may be identified based on movement of the visual object in the distinct frames.

Based on identifying the motion of the external object from at least one of the frames (1130-YES), in operation 1140, the electronic device according to an embodiment may identify whether the external object includes a light source. The electronic device may identify whether the external object identified based on the operation 1130 corresponds to the light source based on areas (e.g., the area 620 of FIG. 6) formed in the frames.

In a state of identifying that the external object includes the light source (1140-YES), in operation 1145, according to an embodiment, the electronic device may synthesize frames based on a first designated synthesis mode to represent the motion of the light source. Based on the first designated synthesis mode, the electronic device may obtain one or more virtual frames distinct from the frames of the operation 1110. The electronic device may synthesize the one or more virtual frames and the frames of the operation 1110 based on an addition calculation based on the signal flowchart 1020 of FIG. 10B. The electronic device may obtain a single image (e.g., the image 730 of FIG. 7) in which a path of the light source is represented based on the synthesis of the one or more virtual frames and the frames of the operation 1110.

In a state of identifying that the external object does not include the light source based on the operation 1140 (1140-NO), in operation 1150, according to an embodiment, the electronic device may synthesize the frames based on a second designated synthesis mode associated with sampling of the frames. Based on the second designated synthesis mode, the electronic device may sample the frames of the operation 1110. Sampling of the frames may be performed based on the motion of the external object identified based on the operation 1130. The electronic device may obtain a single image (e.g., the image 850 of FIG. 8) in which the motion of the external object is represented by synthesizing the sampled frames. The electronic device may synthesize the sampled frames based on a weighted sum calculation based on the signal flowchart 1010 of FIG. 10A.

In a state of identifying that the maximum value of the brightness identified based on the operation 1125 is greater than the designated brightness (1125-No), in operation 1155, according to an embodiment, the electronic device may determine whether the external object includes the light source. In case that the maximum value of the brightness identified based on the operation 1120 is greater than the designated brightness, the electronic device may classify the frames of the operation 1110 into a designated category associated with a daytime scene. In case that the external object includes the light source (1155-YES), the electronic device may synthesize the frames based on the first designated synthesis mode of the operation 1145.

In a state of identifying that the external object does not include the light source based on the operation 1155 (1155-NO), or not identifying the motion of the external object from at least one of the frames based on the operation 1130 (1130-NO), the electronic device may synthesize the frames based on an operation 1160, based on a third designated synthesis mode associated with the interpolation of the frames. Based on the third designated synthesis mode, the electronic device may obtain one or more virtual frames distinct from the frames of the operation 1110. The electronic device may synthesize the one or more virtual frames and the frames of the operation 1110 based on the weighted sum calculation based on the signal flowchart 1010 of FIG. 10A.

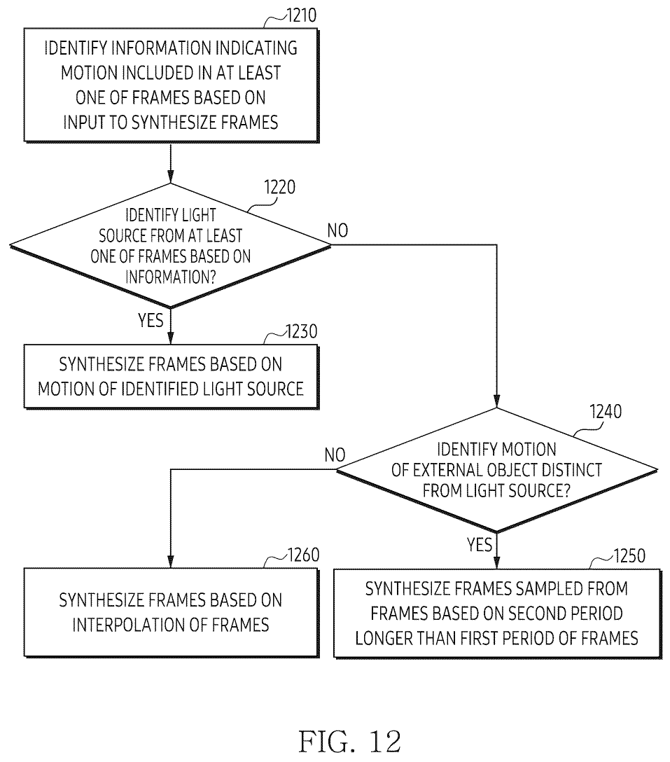

FIG. 12 illustrates an example of a flowchart for describing an operation performed by an electronic device according to an embodiment of the disclosure. The electronic device of FIG. 12 may be an example of the electronic device 101 of FIGS. 3A and 3B, and/or 4. For example, at least one of operations of FIG. 12 may be performed by the electronic device 101 of FIG. 4 and/or the processor 120 of FIG. 4. At least one of the operations of FIG. 12 may be associated with at least one of the operations of FIG. 11.

Referring to FIG. 12, in operation 1210, the electronic device according to an embodiment may identify information indicating a motion included in at least one of the frames based on an input to synthesize the frames. The information may indicate brightness and/or distribution of colors of pixels included in each of the frames based on areas (e.g., the area 620 of FIG. 6) formed in each of the frames. The input to synthesize the frames may include an input indicating that the frames are synthesized based on a slow shutter function. The information may be included in metadata corresponding to the frames or may be obtained by the electronic device based on the input. In an embodiment, the metadata may be obtained based on a camera capturing the frames and/or a server storing the frames.

Referring to FIG. 12, in operation 1220, the electronic device according to an embodiment may identify a light source from at least one of the frames based on information of the operation 1210. For example, the electronic device may identify whether the light source is included in at least one of the frames. Based on a maximum value of the brightness of the areas of each of the frames indicated by the information, the electronic device may identify the light source included in the frames. Based on a deviation in a horizontal direction and/or a vertical direction of the brightness in each of the areas included in the information, the electronic device may identify the light source included in the frames.

Based on identifying the light source from at least one of the frames (1220-YES), in operation 1230, according to an embodiment, the electronic device may synthesize the frames based on the motion of the identified light source. The operation of synthesizing the frames based on the operation 1230 may be performed based on a first designated synthesis mode, similar to the operation 1145 of FIG. 11.

In another state distinct from the state in which the light source is identified from at least one of the frames (1220-NO), in operation 1240, according to an embodiment, the electronic device may identify a motion of an external object distinct from the light source. For example, the electronic device may identify the motion of the external object distinct from the light source from the frames based on the information of the operation 1210. The motion may include an irregular motion included in the frames, such as a motion of a fluid.

Based on identifying the motion of the external object distinct from the light source from at least one of the frames (1240-YES), in operation 1250, according to an embodiment, the electronic device may synthesize the frames sampled from the frames based on a second period longer than a first period of the frames. Sampling the frames based on the operation 1250 may be performed based on a second designated synthesis mode, similar to the operation 1150 of FIG. 11. For example, synthesizing the sampled frames by the electronic device based on the operation 1250 of FIG. 12 may be performed similarly to the operation 1150 of FIG. 11.

In another state distinct from the state of identifying the motion of the external object distinct from the light source from at least one of the frames (1240-NO), in operation 1260, according to an embodiment, the electronic device may synthesize the frames based on interpolation of the frames. Synthesizing the frames by the electronic device based on the operation 1260 of FIG. 12 may be performed based on a third designated synthesis mode, similar to the operation 1160 of FIG. 11. Referring to FIG. 12, based on whether the light source is identified from the frames and/or whether the motion of the external object distinct from the light source is identified from the frames, the electronic device may select the synthesis mode to synthesize the frames.

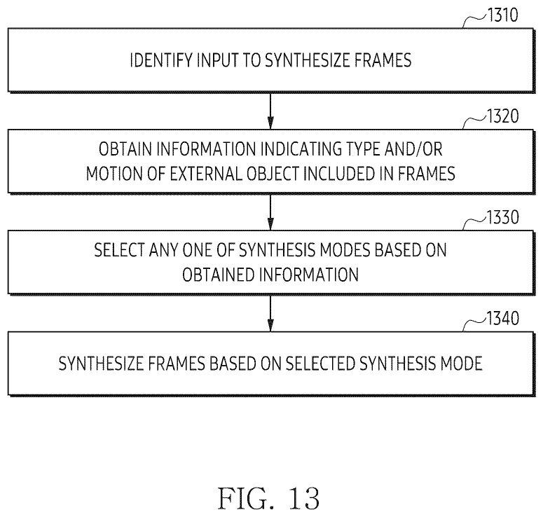

FIG. 13 illustrates an example of a flowchart to describe an operation performed by an electronic device according to an embodiment of the disclosure. The electronic device of FIG. 13 may be an example of the electronic device 101 of FIGS. 3A and 3B, and/or 4. For example, at least one of operations of FIG. 13 may be performed by the electronic device 101 of FIG. 4 and/or the processor 120 of FIG. 4. At least one of the operations of FIG. 13 may be associated with at least one of the operations of FIGS. 11 and 12.

Referring to FIG. 13, in operation 1310, the electronic device according to an embodiment may identify an input to synthesize frames. The input may include an input indicating that the frames are synthesized based on a slow shutter function.

In response to the input of the operation 1310, in operation 1320, according to an embodiment, the electronic device may obtain information indicating a type and/or a motion of an external object included in the frames. The electronic device may select the type of the external object among distinct types to distinguish a light source. The information obtained by the electronic device based on the operation 1320 may include the information identified based on the operation 1210 of FIG. 12.

Referring to FIG. 13, in operation 1330, according to an embodiment, the electronic device may select any one of synthesis modes based on the obtained information. The synthesis modes selected by the electronic device may include the first synthesis mode to the third designated synthesis mode described above with reference to FIG. 4. The operation of selecting the synthesis mode based on the operation 1330 may include the operations 1125, 1130, 1140, and 1155 of FIG. 11, and/or the operations 1220 and 1240 of FIG. 12.

Referring to FIG. 13, in operation 1340, the electronic device according to an embodiment may synthesize the frames based on the synthesis mode selected based on the operation 1330. The operation of synthesizing the frames by the electronic device based on the operation 1340 may include the operations 1145, 1150, and 1160 of FIG. 11, and the operations 1230, 1250, and 1260 of FIG. 12. Based on the synthesis of the frames of the operation 1340, the electronic device may obtain a single image (e.g., the images 515, 525, and 535 of FIG. 5, the image 730 of FIG. 7, the image 850 of FIG. 8, and/or the image 930 of FIG. 9) representing the motion included in the frames.

As described above, the electronic device according to an embodiment may synthesize the frames based on the slow shutter function. For example, the electronic device may obtain the single image from the frames obtained at distinct time points included in a period associated with a long-exposure. Based on a category (e.g., a designated category associated with a night time scene) of a scene captured by the frames, the type (e.g., the light source) of the external object included in the frames, and/or the motion of the external object, the electronic device may select the synthesis mode to synthesize the frames from a plurality of designated synthesis modes (e.g., the first designated synthesis mode to the third designated synthesis mode). The designated synthesis modes may include the synthesis mode to effectively obtain the single image based on the long-exposure from the frames, based on an attribute of the scene captured by the frames.

In an embodiment in which the electronic device includes a camera that repeatedly obtains the frames from an image sensor, a method to support the slow shutter function based on the repeatedly obtained frames may be required.

As described above, according to an embodiment, an electronic device (e.g., the electronic device 101 of FIG. 4) may include memory (e.g., the memory 130 of FIG. 4) storing one or more computer programs, and one or more processors (e.g., the processor 120 of FIG. 4) communicatively coupled to the memory. The one or more computer programs include computer-executable instructions that, when executed by the one or more processors individually or collectively, may cause the electronic device to identify, based on an input to synthesize frames obtained based on a first period, information indicating a motion included in at least one of the frames, obtain, based on identifying at least one light source from at least one of the frames based on the information, an image representing a motion of the at least one light source between the frames, by synthesizing the frames based on the motion of the at least one light source, obtain, based on identifying a motion of an external object distinct from the light source based on the information, an image with respect to the frames by synthesizing one or more frames sampled from the frames based on a second period longer than the first period, and obtain an image in which a path of a least one light source included in the frames is represented based on synthesis of the frames. Independently of a long-exposure performed to obtain a path of the at least one light source, the electronic device may obtain the image including the path.

For example, the one or more computer programs further include computer-executable instructions that, when executed by the one or more processors individually or collectively, may cause the electronic device to obtain, based on interpolation of the frames which are first frames, based on identifying the at least one light source, one or more second frames corresponding to one or more second time points between first time points when the first frames were captured, and obtain the image by synthesizing the first frames and the one or more second frames.

For example, the one or more computer programs further include computer-executable instructions that, when executed by the one or more processors individually or collectively, may cause the electronic device to identify a size of a motion of the light source within the first frames based on the information, and obtain the one or more second frames based on a third period which is corresponding to the identified size, and is shorter than the first period.

For example, the one or more computer programs further include computer-executable instructions that, when executed by the one or more processors individually or collectively, may cause the electronic device to identify a direction to which the at least one light source is moved, in the frames based on the information, and obtain an image with respect to the frames by synthesizing the frames to which a directional filter having the identified direction is applied.

For example, the one or more computer programs further include computer-executable instructions that, when executed by the one or more processors individually or collectively, may cause the electronic device to synthesize, based on identifying the at least one light source, the frames to obtain the image in which a path to which the at least one light source was continuously moved is represented.

For example, the one or more computer programs further include computer-executable instructions that, when executed by the one or more processors individually or collectively, may cause the electronic device to identify, based on distinct areas formed in a first frame among the frames, the information including differences of colors of pixels included in the first frame among the frames.

For example, the electronic device may further include a camera, and a display. The processor may be configured to display a visual object to receive a shooting input within the display. The one or more computer programs further include computer-executable instructions that, when executed by the one or more processors individually or collectively, may cause the electronic device to obtain, in response to the input indicating a selection of the visual object, the frames by controlling the camera.

For example, the one or more computer programs further include computer-executable instructions that, when executed by the one or more processors individually or collectively, may cause the electronic device to identify, in response to the input to synthesize the frames which are at least a portion of a video stored in the memory, the information from metadata corresponding to the video.

For example, the one or more computer programs further include computer-executable instructions that, when executed by the one or more processors individually or collectively, may cause the electronic device to store the obtained image in the memory.

As described above, a method performed by an electronic device according to an embodiment may include identifying, based on an input to synthesize frames obtained based on a camera, brightness of at least one of the frames; obtaining, based on identifying a visual object corresponding to a light source from the frames using the brightness, information associated with a path of the visual object captured by the frames; and obtaining, by synthesizing the frames based on the information, an image in which the path of the visual object is represented.

For example, the identifying may include identifying the visual object corresponding to the light source based on areas respectively formed in the frames.

For example, the obtaining the information may include identifying, based on a first location of the visual object included in a first frame among the frames, and a second location of the visual object included in a second frame after the first frame, a third location of the visual object between the first frame and the second frame; and obtaining the information including a third frame including the visual object which is positioned at the identified third location.

For example, the obtaining the image may include obtaining the image by synthesizing the frames and the third frame included in the information.

For example, the obtaining the image may include changing the frames based on a directional filter based on the path; and obtaining the image by synthesizing the changed frames.

For example, the method may include sampling, in another state different from a state identifying the visual object corresponding to the light source from the frames using the brightness, the frames based on a second period longer than a first period that the frames were captured; and obtaining another image corresponding to the input by synthesizing one or more sampled frames based on the second period among the frames.

As described above, a method performed by an electronic device according to an embodiment may include identifying, based on an input to synthesize frames obtained based on a first period, information indicating a motion included in at least one of the frames; obtaining, based on identifying at least one light source from at least one of the frames based on the information, an image representing a motion of the at least one light source between the frames, by synthesizing the frames based on the motion of the at least one light source; and obtaining, based on identifying a motion of an external object distinct from the at least one light source based on the information, an image with respect to the frames by synthesizing one or more frames sampled from the frames based on a second period longer than the first period.

For example, the obtaining the image based on the at least one light source may include, based on interpolation of the frames which are first frames, based on the at least one light source, obtaining one or more second frames corresponding to one or more second time points between first time points when the first frames were captured; and obtaining the image by synthesizing the first frames and the one or more second frames.

For example, the obtaining the one or more second frames may include identifying a size of a motion of the light source within the first frames based on the information; and obtaining the one or more second frames based on a third period which is corresponding to the identified size, and is shorter than the first period.

For example, the obtaining the image based on the at least one light source may include identifying a direction to which the at least one light source is moved, in the frames based on the information; and obtaining an image with respect to the frames by synthesizing the frames to which a directional filter having the identified direction is applied.

For example, the obtaining the image based on the at least one light source may include synthesizing, based on identifying the at least one light source, the frames to obtain the image in which a path to which the at least one light source was continuously moved is represented.

As described above, an electronic device according to an embodiment may include memory storing one or more computer programs, and one or more processors communicatively coupled to the memory. The one or more computer programs include computer-executable instructions that, when executed by the one or more processors individually or collectively, may cause the electronic device to identify, based on an input to synthesize frames obtained based on a camera, brightness of at least one of the frames, obtain, based on identifying a visual object corresponding to a light source from the frames using the brightness, information associated with a path of the visual object captured by the frames, and obtain, by synthesizing the frames based on the information, an image in which the path of the visual object is represented.

For example, the one or more computer programs further include computer-executable instructions that, when executed by the one or more processors individually or collectively, may cause the electronic device to identify the visual object corresponding to the light source based on areas respectively formed in the frames.

For example, the one or more computer programs further include computer-executable instructions that, when executed by the one or more processors individually or collectively, may cause the electronic device to identify, based on a first location of the visual object included in a first frame among the frames, and a second location of the visual object included in a second frame after the first frame, a third location of the visual object between the first frame and the second frame, and obtain the information including a third frame including the visual object which is positioned at the identified third location.

For example, the one or more computer programs further include computer-executable instructions that, when executed by the one or more processors individually or collectively, may cause the electronic device to obtain the image by synthesizing the frames and the third frame included in the information.

For example, the one or more computer programs further include computer-executable instructions that, when executed by the one or more processors individually or collectively, may cause the electronic device to change the frames based on a directional filter based on the path, and obtain the image by synthesizing the changed frames.

For example, the one or more computer programs further include computer-executable instructions that, when executed by the one or more processors individually or collectively, may cause the electronic device to sample, in another state different from a state identifying the visual object corresponding to the light source from the frames using the brightness, the frames based on a second period longer than a first period that the frames were captured, and obtain another image corresponding to the input by synthesizing one or more sampled frames based on the second period among the frames.

The device described above may be implemented as a hardware component, a software component, and/or a combination of a hardware component and a software component. For example, the devices and components described in the embodiments may be implemented by using one or more general purpose computers or special purpose computers, such as a processor, controller, arithmetic logic unit (ALU), digital signal processor, microcomputer, field programmable gate array (FPGA), programmable logic unit (PLU), microprocessor, or any other device capable of executing and responding to instructions. The processing device may perform an operating system (OS) and one or more software applications executed on the operating system. In addition, the processing device may access, store, manipulate, process, and generate data in response to the execution of the software. For convenience of understanding, there is a case that one processing device is described as being used, but a person who has ordinary knowledge in the relevant technical field may see that the processing device may include a plurality of processing elements and/or a plurality of types of processing elements. For example, the processing device may include a plurality of processors or one processor and one controller. In addition, another processing configuration, such as a parallel processor, is also possible.

The software may include a computer program, code, instruction, or a combination of one or more thereof, and may configure the processing device to operate as desired or may command the processing device independently or collectively. The software and/or data may be embodied in any type of machine, component, physical device, computer storage medium, or device, to be interpreted by the processing device or to provide commands or data to the processing device. The software may be distributed on network-connected computer systems and stored or executed in a distributed manner. The software and data may be stored in one or more computer-readable recording medium.

The method according to the embodiment may be implemented in the form of a program command that may be performed through various computer means and recorded on a computer-readable medium. In this case, the medium may continuously store a program executable by the computer or may temporarily store the program for execution or download. In addition, the medium may be various recording means or storage means in the form of a single or a combination of several hardware, but is not limited to a medium directly connected to a certain computer system, and may exist distributed on the network. Examples of media may include a magnetic medium such as a hard disk, floppy disk, and magnetic tape, optical recording medium such as a CD-ROM and digital versatile disc (DVD), magneto-optical medium, such as a floptical disk, and those configured to store program instructions, including ROM, RAM, flash memory, and the like. In addition, examples of other media may include recording media or storage media managed by app stores that distribute applications, sites that supply or distribute various software, servers, and the like.

As described above, although the embodiments have been described with limited examples and drawings, a person who has ordinary knowledge in the relevant technical field is capable of various modifications and transform from the above description. For example, even if the described technologies are performed in a different order from the described method, and/or the components of the described system, structure, device, circuit, and the like are coupled or combined in a different form from the described method, or replaced or substituted by other components or equivalents, appropriate a result may be achieved.

While the disclosure has been shown and described with reference to various embodiments thereof, and it will be understood by those skilled in the art that various changes in form and details may be made therein without departing from the spirit and scope of the disclosure as defined by the appended claims and their equivalents.

No claim element is to be construed under the provisions of 35 U.S.C. § 112, sixth paragraph, unless the element is expressly recited using the phrase “means for” or “means.”

What is claimed is:

1. An electronic device comprising:
memory storing one or more computer programs; and
one or more processors communicatively coupled to the memory,
wherein the one or more computer programs include computer-executable instructions that, when executed by the one or more processors individually or collectively, cause the electronic device to:
identify, based on an input to synthesize frames obtained based on a first period, information indicating a motion included in at least one of the frames,
obtain, based on identifying at least one light source from at least one of the frames based on the information, an image representing a motion of the at least one light source between the frames, by synthesizing the frames based on the motion of the at least one light source, and
obtain, based on identifying a motion of an external object different from the at least one light source based on the information, an image with respect to the frames by synthesizing one or more frames sampled from the frames based on a second period longer than the first period.

2. The electronic device of claim 1, wherein the one or more computer programs further include computer-executable instructions that, when executed by the one or more processors individually or collectively, cause the electronic device to:
obtain, based on interpolation of the frames which are first frames based on identifying the at least one light source, one or more second frames corresponding to one or more second time points between first time points when the first frames were captured; and
obtain the image by synthesizing the first frames and the one or more second frames.

3. The electronic device of claim 2, wherein the one or more computer programs further include computer-executable instructions that, when executed by the one or more processors individually or collectively, cause the electronic device to:
identify a size of a motion of the at least one light source within the first frames based on the information, and
obtain the one or more second frames based on a third period which is corresponding to the identified size, and is shorter than the first period.

4. The electronic device of claim 1, wherein the one or more computer programs further include computer-executable instructions that, when executed by the one or more processors individually or collectively, cause the electronic device to:
identify a direction to which the at least one light source is moved, in the frames based on the information, and
obtain an image with respect to the frames by synthesizing the frames to which a directional filter having the identified direction is applied.

5. The electronic device of claim 1, wherein the one or more computer programs further include computer-executable instructions that, when executed by the one or more processors individually or collectively, cause the electronic device to:
synthesize, based on identifying the at least one light source, the frames to obtain the image in which a path to which the at least one light source continuously moved is represented.

6. The electronic device of claim 1, wherein the one or more computer programs further include computer-executable instructions that, when executed by the one or more processors individually or collectively, cause the electronic device to:
identify, based on distinct areas formed in a first frame among the frames, the information including differences of colors of pixels included in the first frame among the frames.

7. The electronic device of claim 1, further comprising:
a camera; and
a display,
wherein the one or more computer programs further include computer-executable instructions that, when executed by the one or more processors individually or collectively, cause the electronic device to:
display a visual object to receive a shooting input within the display, and
obtain, in response to the input indicating a selection of the visual object, the frames by controlling the camera.

8. The electronic device of claim 1, wherein the one or more computer programs further include computer-executable instructions that, when executed by the one or more processors individually or collectively, cause the electronic device to:
identify, in response to the input to synthesize the frames which are at least a portion of a video stored in the memory, the information from metadata corresponding to the video.

9. The electronic device of claim 1, wherein the one or more computer programs further include computer-executable instructions that, when executed by the one or more processors individually or collectively, cause the electronic device to:
store the obtained image in the memory.

10. A method performed by an electronic device, the method comprising:
identifying, based on an input to synthesize frames obtained based on a camera, brightness of at least one of the frames;
obtaining, based on identifying a visual object corresponding to a light source from the frames using the brightness, information associated with a path of the visual object captured by the frames; and
obtaining, by synthesizing the frames based on the information, an image in which the path of the visual object is represented.

11. The method of claim 10, wherein the identifying comprises:
identifying the visual object corresponding to the light source based on areas respectively formed in the frames.

12. The method of claim 10, wherein the obtaining the information comprises:
identifying, based on a first location of the visual object included in a first frame among the frames and a second location of the visual object included in a second frame after the first frame, a third location of the visual object between the first frame and the second frame; and
obtaining the information including a third frame including the visual object which is positioned at the identified third location.

13. The method of claim 12, wherein the obtaining the image comprises:
obtaining the image by synthesizing the frames and the third frame included in the information.

14. The method of claim 10, wherein the obtaining the image comprises:
changing the frames based on a directional filter based on the path; and
obtaining the image by synthesizing the changed frames.

15. The method of claim 10, further comprising:
sampling, in another state different from a state identifying the visual object corresponding to the light source from the frames using the brightness, the frames based on a second period longer than a first period that the frames were captured; and
obtaining another image corresponding to the input by synthesizing one or more sampled frames based on the second period among the frames.

16. A method performed by an electronic device, the method comprising:
identifying, based on an input to synthesize frames obtained based on a first period, information indicating a motion included in at least one of the frames;
obtaining, based on identifying at least one light source from at least one of the frames based on the information, an image representing a motion of the at least one light source between the frames, by synthesizing the frames based on the motion of the at least one light source; and
obtaining, based on identifying a motion of an external object different from the at least one light source based on the information, an image with respect to the frames by synthesizing one or more frames sampled from the frames based on a second period longer than the first period.

17. The method of claim 16, wherein the obtaining the image based on the at least one light source comprises:
obtaining, based on interpolation of the frames which are first frames based on identifying the at least one light source, one or more second frames corresponding to one or more second time points between first time points when the first frames were captured; and
obtaining the image by synthesizing the first frames and the one or more second frames.

18. The method of claim 17, wherein the obtaining the one or more second frames comprises:
identifying a size of a motion of the at least one light source within the first frames based on the information; and
obtaining the one or more second frames based on a third period which is corresponding to the identified size, and is shorter than the first period.

19. The method of claim 16, wherein the obtaining based on the at least one light source comprises:
identifying a direction to which the at least one light source is moved, in the frames based on the information; and
obtaining an image with respect to the frames by synthesizing the frames to which a directional filter having the identified direction is applied.

20. The method of claim 16, wherein the obtaining based on the at least one light source comprises:
synthesizing, based on identifying the at least one light source, the frames to obtain the image in which a path to which the at least one light source was continuously moved is represented.
